(19) United States
(12) Patent Application Publication
(10) Pub. No.: US 2012/0213148 A1
(43) Pub. Date: Aug. 23, 2012

(54) WIRELESS COMMUNICATION SYSTEM HAVING RELAY DEVICE, AND METHOD FOR SELECTING RELAY TERMINAL

(75) Inventors: Toshiyuki Saito, Tokyo (JP); Kenzaburo Fujishima, Yokohama (JP); Rintaro Katayama, Fujisawa (JP); Koki Uwano, Fujisawa (JP)

(73) Assignee: HITACHI, LTD., Chiyoda-ku, Tokyo (JP)

(21) Appl. No.: 13/503,881

(22) PCT Filed: Nov. 2, 2009
(86) PCT No.: PCT/JP2009/005815

§ 371 Date: Apr. 25, 2012

(51) Int. Cl. H04W 40/00; H04B 7/14

(52) U.S. Cl. 370/315

(57) ABSTRACT

In wireless communication systems into which a relay device has been introduced, although terminal reception quality increases, data transmission by relay devices with low contribution causes interference in other data transmission, which invites a decrease in reception quality of electromagnetic waves received by terminals. As a way to resolve the abovementioned issue, as one embodiment of the present disclosures, a wireless relay station is configured so as to receive a plurality of data addressed for wireless terminals from a wireless base station, and to transmit data that are selected from the aforementioned received plurality of data and that are addressed to the aforementioned wireless terminals which are the destinations of transmission. As a result, interference towards other data transmission and reception caused by data transmission of a relay device can be suppressed, and the reception quality of electromagnetic waves received by the terminal can be increased.

### TECHNICAL FIELD

This invention relates to a base station, a terminal, and a relay device, and also to a wireless communication system having the same.

### BACKGROUND ART

In a wireless communication system, a fixed station (base station) is arranged on the assumption of a moving range of a mobile station (terminal). Specifically, a plurality of base stations are arranged, thereby areas (cells) in which each base station communicating with the terminal overlap each other. The base stations are arranged such that the terminal can communicate with any of the base stations no matter where the terminal is located in the assumed moving range. However, in fact, a dead zone is generated. In this dead zone, the terminals cannot communicate with the base station, due to an effect of a restriction on the location of the base station arrangement and shielding, such as a building, and the like. To reduce such a dead zone, a relay device for relaying wireless communication between the base station and the terminal is introduced. This relay device is of type “Amplify & Forward”, and has a function for amplifying and transmitting received signals.

The “AF” type relay device has a simple device configuration, because a baseband signal process is not performed. Noise at a reception end is amplified. Thus, an SNR (Signal to Noise Ratio) of the relayed signal will not be greater than the SNR at the reception end of the relay device. On the contrary, there is another known relay device which is of type “Decode & Forward type (DF type)”. In this relay device, the baseband signal process is performed in the relay device, and a received signal is once decoded back into a data bit sequence. Then, the same data bit sequence is encoded again, thereby removing noise components at the stage where the relay device performs transmission. With this device, the SNR in the transmission of the relay device can be greater than the SNR at the reception end.

As disclosed in Non-patent literature 1 to Non-patent standardization organization of mobile communication promotes to standardize LET-Advanced (hereinafter referred to as LTE-A) as the incoming standard of LTE (Long Term Evolution), for IMT-Advanced. In LTE-A, to improve average spectral efficiency of cells and spectral efficiency of cell edges, introduction of a DF type relay device has been examined. Similarly, the standardization organization “IEEE” (Institute of Electrical and Electronics Engineers) promotes to standardize “IEEE 802.16m” as the incoming standard of WiMAX (Worldwide Interoperability for Microwave Access). Similarly, introduction of a DF type relay device has been examined.

In 3GPP, the relay device is defined as a node having a wireless backhaul circuit with respect to a donor base station (Non-patent literature 1). In Non-patent literature 1, as the wireless backhaul circuit, two of Inband backhaul and Outband backhaul are being examined. The former one keeps a radio communication resource for backhaul circuit using a part of a radio communication resource for use in data communication, while the latter one keeps a radio communication resource for backhaul circuit independently from the radio communication resource for use in data communication. The latter one can easily manage the radio communication resource. However, in an extreme example, if there is no need to use the backhaul circuit at all, the radio communication resource allocated as one for backhaul circuit cannot be diverted to one for data communication, thus likely to lower the spectral efficiency.

If the relay device is introduced, a plurality of routes are generated between the base station and the terminal. The routes include a route for direct communication between the base station and the terminal and a route for communicating through the relay device. A routing technique for judging which route is used for actual communication is disclosed, for example, in Patent literature 1. Further, the routing technique, of a case in which a plurality of relay devices exist between the base station and the terminal, is disclosed in Patent literature 2.

Further, Non-patent literature 5 proposes a Cooperative Relay as a utilization scheme of the relay device, in 3GPP. According to the disclosed technique, in the Coorperative Relay, as shown in FIG. 2, the relay device decodes and keeps a data signal transmitted by the base station. When the terminal feeds back a NACK signal representing a reception failure to the base station, the relay device intercepts this feed back. When the base station transmits retransmission packets, the relay device also transmits (Cooperative Transmission) the same retransmission packets based on the kept result. In this method, the number of retransmissions of H-ARQ (Hybrid Automatic Repeat request) can be decreased.

### CITATION LIST

### Patent Literature

[PTL 1] Japanese Patent Application laid-Open Publication No. 2008-048202
[PTL 2] WO2006/104105

### Non-Patent Literature

[NPL 1] 3GPP, “Further advancements for E-UTRA Physical layer aspects”, TR36.814, v1.0.0, 2009/02.
[NPL 2] 3GPP, “Physical Channel and Modulation (Release 8)”, TS36.211, v8.70, 2009/05.
[NPL 3] 3GPP, “Multiplexing and channel coding (Release 8)”, TS36. 212, v8.7.0, 2009/05.
[NPL 4] 3GPP, “Physical layer procedures (Release 8)”, TS36. 213, v8.7.0, 2009/05.
[NPL 5] Vodafone, “Further considerations on L2 transparent relay”, R1-091403, 3GPP TSG-RAN WG1, 2009/03.

### SUMMARY OF INVENTION

### Technical Problem

Patent literature 1 and Patent literature 2 disclose wireless communication systems in which a conventional relay device has been introduced. In each of the systems, a relay device transmits data to the entire destinations of data received from a base station. In this transmission, communication quality between a terminal and a relay device may be deteriorated due to a condition that a destination terminal of data and the relay device are geographically far from each other. In this case, the transmission of data for the terminal by the relay device makes only a very little contribution to improvement of reception quality of the terminal. Such data transmission that makes only a very little contribution to improvement of the reception quality of the terminal causes interference to another data transmission in its cell or interference to data transmission in another cell. This results in a decrease reception quality of radio waves received by the terminal.

A problem to be addressed by the present invention is that data transmission by the relay device causes interference to another data transmission, thus resulting in a decrease in reception quality of radio waves received by the terminal.

### Solution to Problem

To address the at least one problem, according to an aspect of the present invention, a wireless relay station may receive a plurality of data items addressed to a wireless terminal from a wireless base station, and transmit the received data addressed to a first wireless terminal as a selected destination wireless terminal for data transmission, of the wireless terminal.

According to a specific configuration example of the above aspect, there are provided a wireless communication system and a relay terminal selection method in a wireless relay station, including: a wireless base station; a plurality of wireless relay stations; and a plurality of wireless terminals which can communicate with the base station through the relay stations, wherein the wireless relay station receives data addressed to the plurality of wireless terminals from the wireless base station, judges a first wireless terminal as a destination wireless terminal for data transmission, from the plurality of wireless terminals, and transmits the data to the judged first wireless terminal.

Further, according to another specific configuration example of the above aspect, there are provided a wireless communication system and a relay terminal selection method, the wireless communication system including: a wireless base station; a plurality of wireless relay stations which can communication with the wireless base station; and a plurality of wireless terminals which communicate with the wireless base station through the wireless relay stations, and wherein the plurality of wireless relay stations have a destination terminal list representing the wireless terminals as destinations, receive relay control data about the wireless terminal as a destination and a wireless resource used for transmitting the data to the wireless terminals, from the wireless base station, judge a first wireless terminal as a destination wireless terminal for data transmission, based on the destination terminal list, and transmit the data to the judged first wireless terminal, using a corresponding wireless resource.

To address the at least one problem, according to still another aspect of the present invention, in a configuration of the above means, a base station transmits data addressed to a destination wireless terminal using a first wireless resource representing correspondence with the wireless terminal as a destination for transmission, as a wireless resource used by the wireless relay station for transmitting data to the destination wireless terminal for transmission. According to a specific configuration example of this aspect, a wireless relay station receives, from a wireless base station, relay control information representing correspondence between a wireless resource used by the wireless relay station for transmitting data addressed to a wireless terminal and the wireless terminal and data addressed to the wireless terminal, judges the first wireless resource used for transmitting data addressed to a first wireless terminal based on the received relay control information, and transmits data addressed to the first wireless terminal using the first wireless resource.

### Advantageous Effects of Invention

It is possible to improve reception quality of radio waves received by a terminal, by lowering occurrence of interference against another data transmission due to data transmission of a relay device.

### BRIEF DESCRIPTION OF DRAWINGS

FIG. 1A is a diagram for schematically explaining a wireless communication system in which a relay device is introduced.

FIG. 1B is a diagram for explaining resource partitioning in the wireless communication system in which the relay device is introduced.

FIG. 2 is a diagram showing an example of the cooperative transmission timing between a base station and the relay device.

FIG. 3 is a diagram showing one configuration of the wireless communication system applied for each embodiment.

FIG. 4A is a diagram showing the flow of OFDM data transmission in direct communication between the base station and a terminal.

FIG. 4B is a diagram showing the flow of OFDM data transmission when the base station and the terminal communicating with each other through the relay device.

FIG. 5 is a diagram showing one example of a format of data transmitted from the base station to the relay device.

FIG. 6A is a diagram showing an example of an operational flowchart of the relay device.

FIG. 6B is a diagram showing an example of a format of a data buffer that is received by the relay device.

FIG. 7 is a conceptual diagram of data transmission when the terminal is in soft handover, in the wireless communication system performing communication through the relay device.

FIG. 8 is a diagram for explaining the flow of OFDM data transmission in a first embodiment.

FIG. 9 is a diagram showing a conceptual diagram of data transmission in the first embodiment.

FIG. 10 is a diagram for explaining the flow of OFDM data in a second embodiment.

FIG. 11 is a diagram showing a conceptual diagram of data transmission in the second embodiment.

FIG. 12 is a conceptual diagram for a method for forming a destination terminal list in a third embodiment.

FIG. 13 is a diagram showing an example of a corresponding list of terminal IDs and SRS transmission patterns in the third embodiment.

FIG. 14 is a diagram showing an example of an operational flowchart of the relay device in the third embodiment.

FIG. 15 is a diagram showing an operational sequence of the entire system in the third embodiment.

FIG. 16 is a conceptual diagram of data transmission in a fourth embodiment.

FIG. 17 is a diagram showing an example of a functional block configuration of the base station, according to each embodiment.

FIG. 18 is a diagram showing an example of a device configuration of the base station, according to each embodiment.

FIG. 19 is a diagram showing a specific example of a device for realizing estimation on a propagation channel response of a plurality of wireless communication channels, using a plurality of reference signals that overlap each other at the same time and in the same frequency, according to each embodiment.

FIG. 20 is a diagram showing an example of a conversion table for conversion from channel quality indexes (CQI) to capacities.

FIG. 21 is a diagram showing an example of a functional block configuration of the relay device, according to each embodiment.

FIG. 22 is a diagram showing an example of a functional block configuration regarding downlink communication of the relay device, according to each embodiment.

FIG. 23 is a diagram showing an example of a functional block configuration regarding uplink communication of the relay device, according to each embodiment.

FIG. 24 is a diagram showing an example of a device configuration of the relay device, according to each embodiment.

FIG. 25 is a diagram showing an example of a functional block configuration of the terminal, according to each embodiment.

FIG. 26 is a diagram showing an example of a device configuration of a terminal device 102, according to each embodiment.

FIG. 27 is conceptual diagram of data transmission in a fifth embodiment.

FIG. 28 is a diagram showing an example of a corresponding list of group IDs and belonging relay devices, in the fifth embodiment.

FIG. 29 is a diagram showing an example of a configuration for controlling retransmission between the relay device and the terminal, by securing resources for retransmission.

### DESCRIPTION OF EMBODIMENTS

Various embodiments of the present invention will now be described in accordance with the drawings. A wireless communication system including a relay device will now schematically be described. In this specification, note that a wireless base station is referred to or illustrated as a base station, a fixed station, a Base Station or BS, a wireless terminal is referred to as a terminal, a mobile station, a Mobile Station or MS, and a wireless relay device is referred to as a relay device, a wireless relay station, a relay station, a Relay Station or RS. Descriptions will now be made to the embodiments of the present invention, based on some examples of a wireless communication system or each device, in accordance with standards, such as LTE, LTE-A, WiMAX. It is obvious, however, that the present invention is applicable other than these wireless communication system or devices.

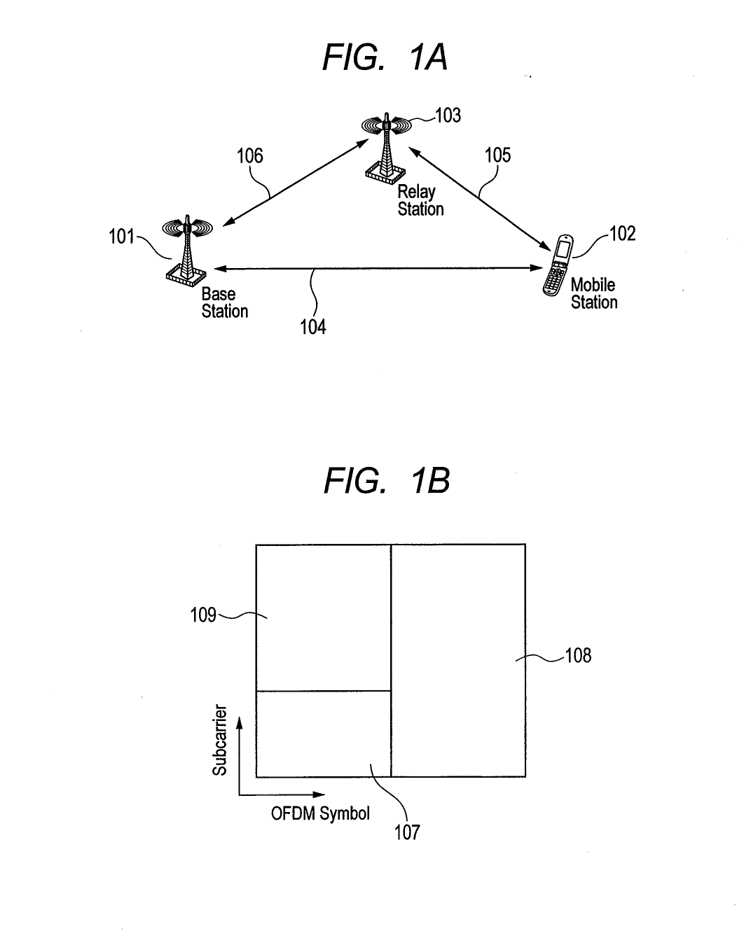

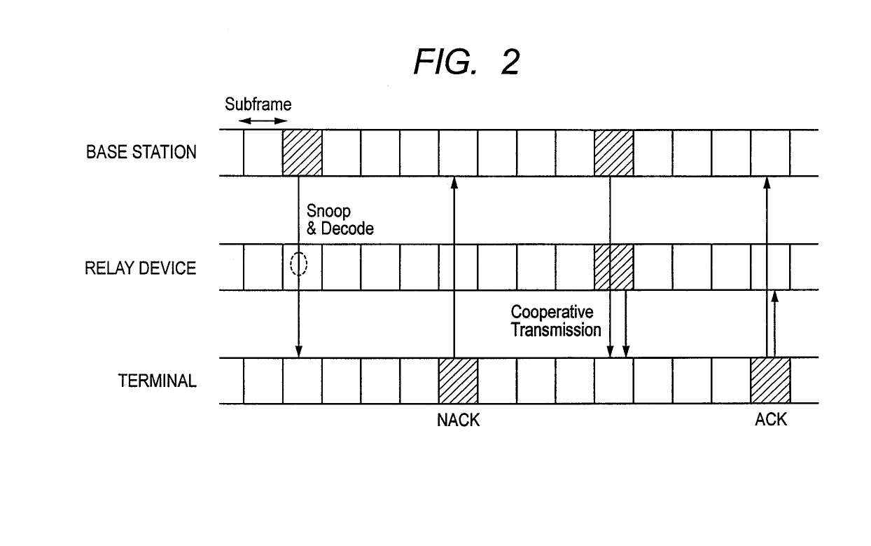

FIG. 1A shows a basic configuration of a wireless communication system in which a relay device is introduced. A relay device 103 is introduced into the wireless communication system, in which a base station 101 and a terminal 102 perform data communication. Upon this introduction, in addition to a wireless communication channel 104 (first wireless communication channel) between the base station and the terminal, a wireless communication channel 105 (second wireless communication channel) between the relay device and the terminal and a wireless communication channel 106 (third wireless communication channel) between the base station and the relay device are generated. That is, as the wireless communication route between the base station and the terminal, the first route (using the first wireless communication channel 104) and the second route (using the second wireless communication channel 105 and the third wireless communication channel 106) are generated.

FIG. 1B shows an example of resource partitioning in the wireless communication, in the wireless communication system in which the relay device is introduced. The radio communication resources include a time resource (time slot, clock time, etc.), like an OFDM symbol 10001 and a frequency resource which is a frequency band, like a sub-carrier 10002. In the descriptions below, the OFDM symbol 10001 is used as a time slot by way of example, while the sub-carrier 10002 is used as a frequency band. However, it is obvious that the present invention is not limited to these, and is applicable to other cases. The resource partitioning is achieved in such a manner that a radio communication resource 107 is allocated to the first wireless communication channel 104, a radio communication resource 108 is allocated to the second wireless communication channel 105, and a radio communication resource 109 is allocated to the third wireless communication channel 106.

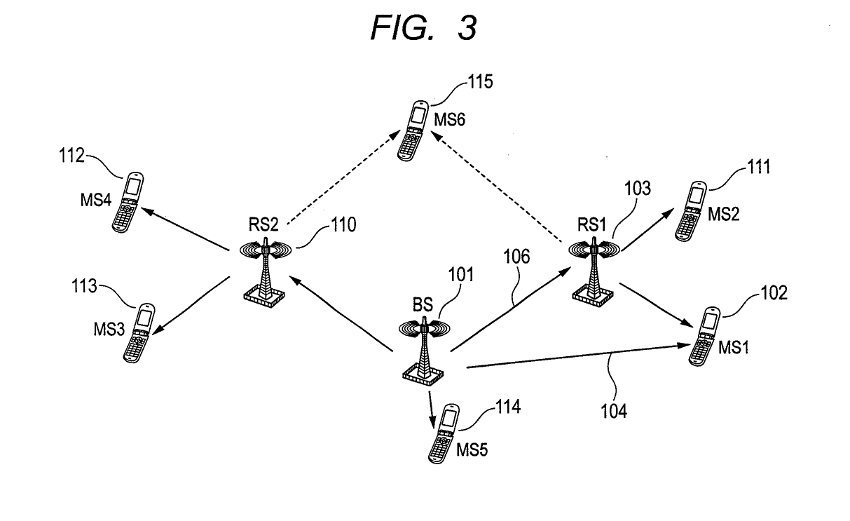

In this system, as shown in FIG. 3, a plurality of relay devices are connected to one base station, and a plurality of terminals exist in the service area. The base station 101, the relay device 103, and the terminal 102 are the same as those of FIG. 1. A second relay device 110 is connected to the base station 101. The first and second terminals 102 and 111 receive data from the base station 101 through the first relay device 103. A third and fourth terminals 112 and 113 receive data from the base station 101 through the second relay device 110. A fifth terminal 114 receives data directly from the base station 101. A sixth terminal 115 needs to receive data through the relay device, and intermediately exists at an equal long distance from the two relay devices 103 and 110.

In this system, “Inband Backhaul” described in the Background of the invention is applied. In this case, the radio communication resource used by the base station 101 for data transmission/reception is shared between the first wireless communication channel 104 and the third wireless communication channel 106. In this case, in the data communication through the third wireless communication channel 106, the base station 101 transmits transmission data of the second wireless communication channel 105 to the relay device 103. The data communication does not contribute to the throughput of the system, that is, the amount of data to be received by the terminal per unit time. Thus, the efficient utilization of the radio communication resource can be improved, and the throughput of the system can be enhanced, by reducing the used radio communication resources of the third wireless communication channel 106 when transmitting communication data of the second wireless communication channel 105.

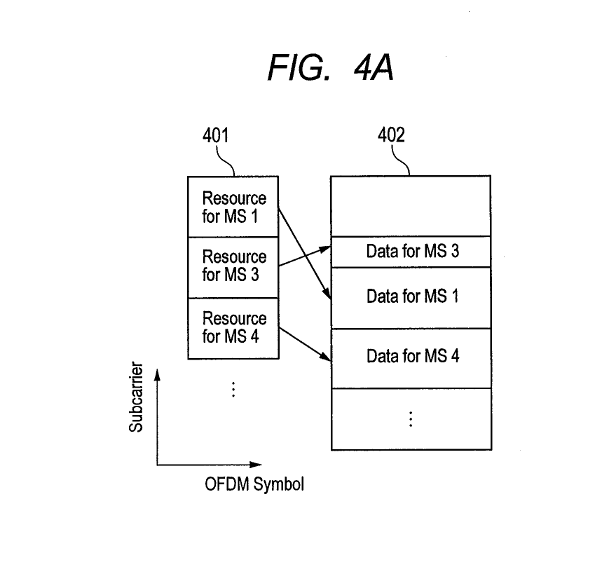

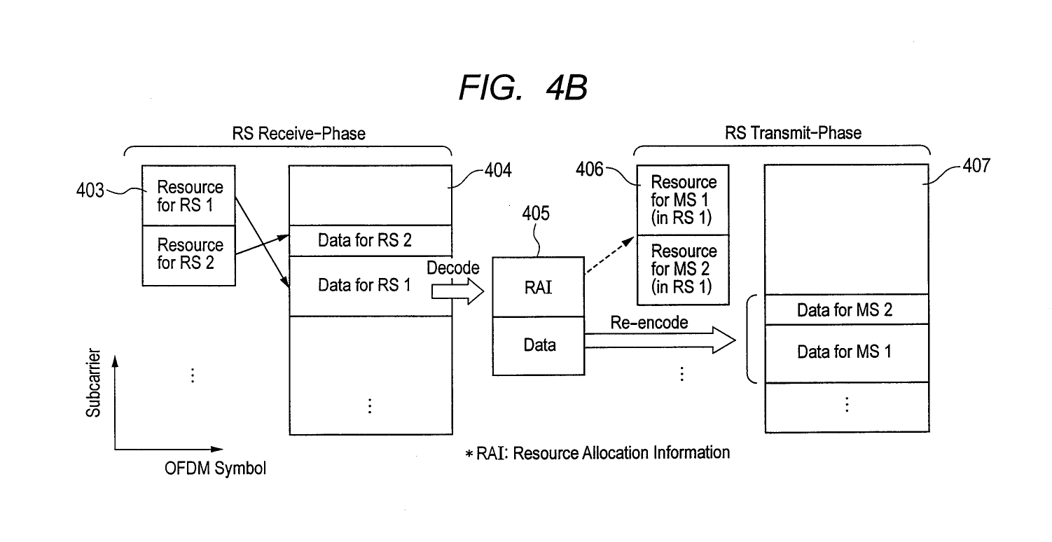

The relay device, for example, in “LTE-A” is defined briefly in two forms (a first form and a second form). In the first form, the relay device itself allocates the wireless resource of the second wireless communication channel 105. In the second form, the relay device itself does not allocate the resource of the second wireless communication channel 105. In the second form, the base station device allocates the wireless resources of the first wireless communication channel 104, the second wireless communication channel 105, and the third wireless communication channel 106. A difference between the first form and the second form is made as to whether the third wireless communication channel 106 needs to send Resource Allocation Information (RAI) of the second wireless communication channel 105 as relay control information. Descriptions will now be made to the second form, by way of example. However, this embodiment is applicable also to the first form. Descriptions will now specifically be made to a communication method in the wireless communication system in which such a relay device is introduced. In general, wireless communication is achieved from the base station 101 to the terminal in a configuration shown in FIG. 4A.

In the same illustration, a reference numeral 401 identifies a first communication channel control signal as a control signal for use in data transmission/reception in the first wireless communication channel, while a reference numeral 402 identifies a first communication channel data signal including data to be transmitted/received through the first wireless communication channel. The base station 101 judges a target terminal to which data is transmitted, its transmission time, and a frequency resource and MCS (Modulation and Coding Scheme) of a wireless resource to be used, in the first communication channel data signal 402. This operation is generally referred to as scheduling. Now, for a target for data transmission, the first communication channel control signal 401 is generated and sent to the terminal. This signal 401 represents an ID of a destination terminal for data, the data transmission time, and the frequency resource and modulation scheme for use in the data transmission. In the following descriptions, allocation of a time resource for data transmission and allocation of a frequency resource for data transmission are referred to as resource allocation.

Upon reception of the first communication channel control signal 401, the terminal judges whether there is an allocated resource addressed to the terminal itself. When judged that there is an allocated resource, the frequency resource specified in the first communication channel data signal 402 is demodulated/decoded, thereby receiving the data. This signal 402 is transmitted at a corresponding clock time. The descriptions have been made based on an assumption that the first communication channel control signal 401 and the first communication channel data signal 402 are discontinuous in time. However, information regarding the transmission time may be omitted, by continuously arranging the signals 401 and 402 in time and forming the signal 401 to have the contents representing the information of the continuous signal 402.

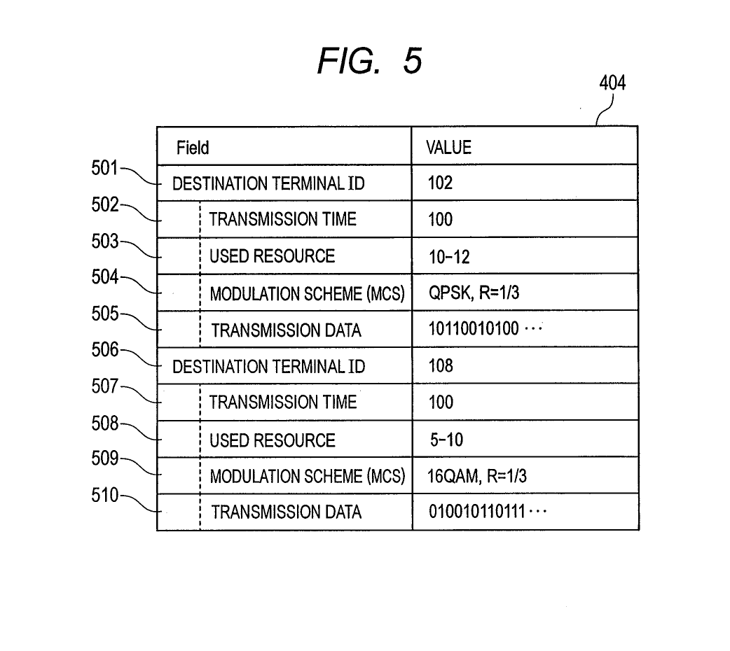

Using the same configuration, communication through the relay device can be realized using a configuration shown in FIG. 4B. FIG. 4B shows an example of operations of the first relay device 103. Operations of any other relay device 110 are the same as the illustrated operations. The base station 101 forms a third wireless communication channel data signal 404 as data addressed to each relay device in the third wireless communication channel. A reference numeral 405 represents information to be transmitted through the second wireless communication channel 105 and received by the first relay device 103, and the information includes resource allocation information (RAI) as relay control information and data. FIG. 5 shows an example of a format of the third wireless communication channel data signal 404 for the relay device 103.

As shown in FIG. 5, fields of the third wireless communication channel data signal 404 store information included in a second wireless communication channel control signal 406 as a control signal to be used when the relay device 103 transmits data addressed to each terminal using a second wireless communication channel data signal 407 through the second wireless communication channel 105. That is, the fields store an ID 501 of the destination terminal of first transmission data, its transmission time 502, a used frequency resource 503, an MCS 504, and first transmission data 505. Also for second transmission data, information items 506 to 510 corresponding to the fields 501 to 506 are stored. Similarly, the same information is stored for each data to be transmitted by the relay device 103 using the second wireless communication channel data signal 407. The first transmission data and the second transmission data are included in data addressed to each terminal and transmitted using the second wireless communication channel data signal 407. After mapping thus formed transmission data into the third wireless communication channel data signal 404, the base station 101 generates a third wireless communication channel control signal 403. The configuration of the third wireless communication channel control signal 403 is the same as that of the first wireless communication channel control signal 401. In the following descriptions, a control signal used for data transmission/reception in the first wireless communication channel is defined as a first communication channel control signal, a signal including data to be transmitted/received through the first wireless communication channel is defined as a first communication channel data signal, a control signal used for data transmission/reception in the second wireless communication channel is defined as a second communication channel control signal, a signal including data to be transmitted/received through the second wireless communication channel is defined as a second communication channel data signal, a control signal used for data transmission/reception in the third wireless communication channel is defined as a third communication channel control signal, and a signal including data to be transmitted/received through the third wireless communication channel is defined as a third communication channel data signal.

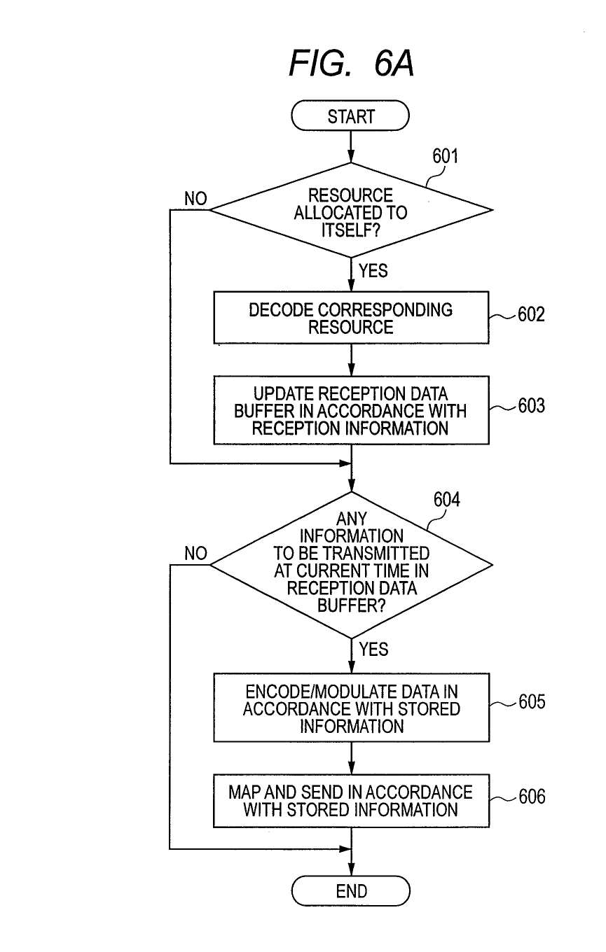

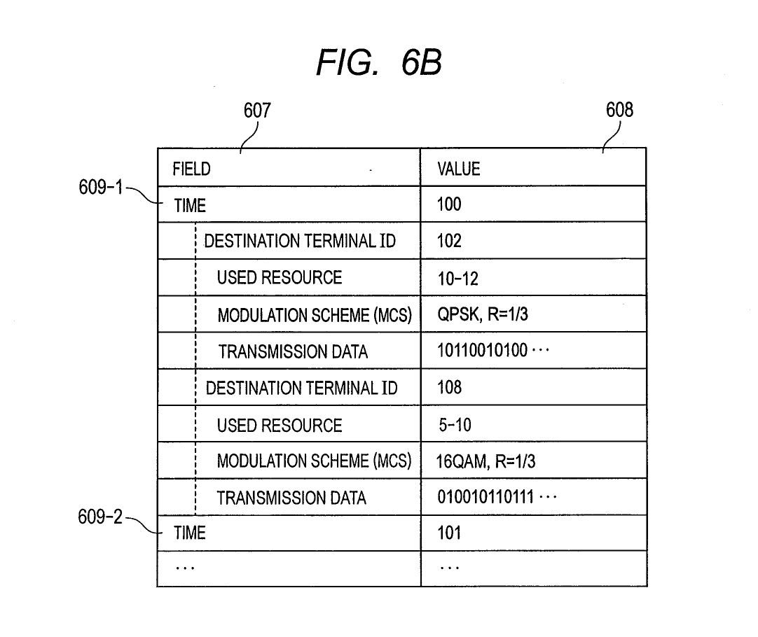

FIG. 6A shows a flowchart of an operation of the relay device 103. The relay device 103 receives data in accordance with the same operation as that of the terminal 102 in the first wireless communication channel 104, for the third wireless communication channel 106. Specifically, the third wireless communication channel control signal 403 is received, and verification is made as to whether there is an allocated resource addressed to the relay device itself (601). When there is an allocated resource, a specified frequency resource of the third communication channel data signal 404 transmitted at a corresponding time is demodulated and decoded in accordance with a specified modulation scheme, thereby receiving data (602). After this, the data stored in the format of FIG. 5 is stored in a reception data buffer provided inside the relay device 103.

The reception data buffer manages a data transmission schedule regarding the second wireless communication channel 105 of the relay device 103, using a format of FIG. 6B, that is, values 608 corresponding respectively to fields 607, for example. The reception data buffer puts the information of FIG. 5 in order, based on times 609-1 and 609-2 corresponding to the transmission times 502 and 507. The relay device 103 compares transmission time information of this reception data buffer and the current time (604). If there is any data to be transmitted at the current time, the device modulates and encodes the transmission data 505 or 510 in accordance with a corresponding MCS, generates transmission data of the second wireless communication channel data signal 407 (605), and sends the generated data using a corresponding frequency resource (606).

According to the configuration of this system, the frequency resource in, for example, the second wireless communication channel 105 and the frequency resource in the first wireless communication channel 104 can individually be allocated. Thus, resources are allocated in a manner suitable for the communication channel circumstances of the respective first wireless communication channel 104 and the second wireless communication channel 105, thereby reducing the possibility of decreasing the cell throughput due to interference, etc. For example, a resource (MIMO: Multiple Input Multiple Output) best suited to cooperation between base stations is a radio communication resource which results in a decrease in the throughput due to interference in the same cell of the first wireless communication channel 104. In this case, this resource is selected only in the resource allocation in the second wireless communication channel 105, thereby enabling to prevent occurrence of interference in its cell and to contribute to throughput improvement of the entire system.

The second wireless communication channel control signal 406 of FIG. 4B may be transmitted by the relay device 103 itself or the base station 101, based on the stored resource allocation information (RAI) items 501 to 504 or 506 to 509. The terminals 102 and 111 which receive data from the base station 101 through the relay device 103 can receive data from the second wireless communication channel control signal 406 and the second wireless communication channel data signal 407 in accordance with the same operation as that of the terminal in FIG. 4A.

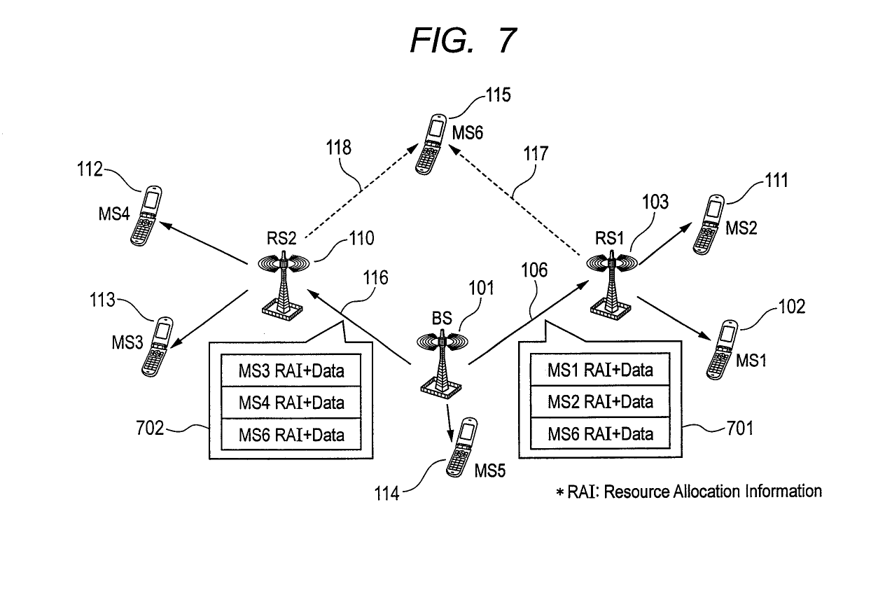

In the above-described system, a consideration is given to transmission for the sixth terminal 115 in the configuration of FIG. 3. In general, in a known soft handover technique, for a terminal which is farthest from any base stations, a plurality of neighborhood base stations send the same data at the same time and in the same frequency resource in cooperation with each other. This improves reception quality of the terminal that is shown in an SNR. A configuration of FIG. 7 is necessary for realizing a soft handover state in which the sixth terminal 115 receives data from both of the relay devices 103 and 110, as shown in FIG. 3.

In FIG. 7, a third wireless communication channel data signal 701 and a third wireless communication channel data signal 702 include transmission data of second wireless communication channels 117 and 118, which are addressed to the terminal 115. The signal 701 goes through the third wireless communication channel 106, and is addressed to the first relay device 103. The signal 702 goes through a third wireless communication channel 116, and is addressed to the second relay device 110. The third wireless communication channel data signals 701 and 702 are thus configured. In addition, the same transmission time, the same frequency resource, and the same MCS are applied, in the second wireless communication channels 117 and 118. According to this, the relay devices 103 and 110 send the same signal to the terminal 115. In other words, as a result of the cooperative communication, the terminal 115 can realize a soft handover state.

In this case, in proportion to the number of terminals in a soft handover state and the number of relay devices participating the cooperative communication, the resources of the third wireless communication channel data signal 404 are increasingly used. To realize the soft handover state, different third wireless communication channel data signals include the same information. This deteriorates resource utilization efficiency of the system in exchange for communication quality improvement of the terminals.

Further, in this configuration, to realize the soft handover state, the base station needs to have information to judge whether nor not the soft handover state is necessary, in association with the entire terminals receiving data through the relay device, and the third wireless communication channel data signal needs to be formed based on this judgment result. Therefore, an amount of information processing to be performed by the base station is increased, and the used memory size is also increased. This results in deterioration of tracking on movement of the terminal.

### First Embodiment

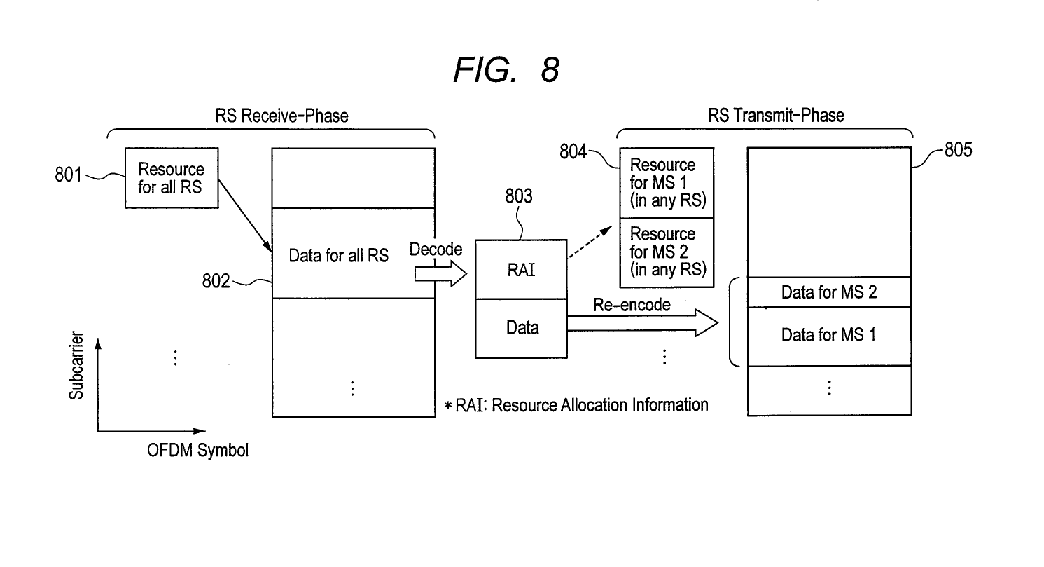

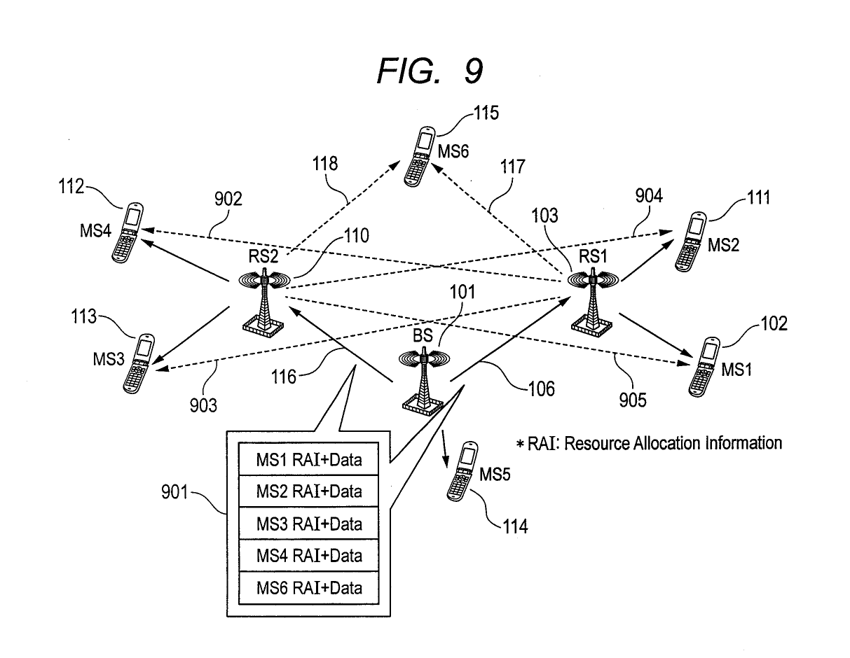

A configuration of the first embodiment for addressing this problem is shown in FIGS. 8 and 9. Descriptions will first be made to a control configuration of this embodiment with reference to FIG. 8. The base station 101 gathers information 803 including the RAI of the second wireless communication channel and second wireless communication channel transmission data, in association with the entire terminals 102, 111, 112, 113, and 115 that receive data through any of the relay devices 103 and 110, based on the format shown in FIG. 5. The kept information is set as a third wireless communication channel data signal 802. In the third wireless communication channel control signal 801, the base station specifies the transmission time, the used frequency resource and the MCS of the third wireless communication channel data signal 802, using a destination ID common to the entire relay devices. By using the common destination ID, the entire relay devices 103 and 110 perform a process for receiving the third wireless communication channel data signal 802. As a result, the entire of the relay devices 103 and 110 send a second wireless communication channel data signal 805 of the entire terminals which receive data through the relay device. A second wireless communication channel control signal 804 may be transmitted by the base station 101 or the relay devices 103 and 110, as shown in FIG. 4B.

FIG. 9 shows a state of data transmission in the system of this embodiment. The first difference from the configuration of FIG. 7 is that transmission information of the third wireless communication channels 106 and 116 forwarded to the two relay devices 103 and 110 is common information 901. As the information 901, the RAI and the transmission data are transmitted. This RAI corresponds to the second wireless communication channel of the entire terminals 102, 111, 112, 113, and 115 that receive data through the relay device 103 or 110. The second difference from the above configuration is that transmission signals 902, 903, 904, and 905 are newly generated. Specifically, the signals 902 and 903 are from the first relay device 103 to the terminals 112 and 113 which have received data from the base station through the second relay device 110. The signals 904 and 905 are from the second relay device 110 to the terminals 102 and 111 which have received data from the base station through the first relay device 103.

According to this embodiment, the terminal 115 is in a soft handover state in which the terminal 115 receives data automatically from both of the relay devices 103 and 110. Thus, the base station 101 does not need to judge whether the terminal 115 needs to be in a soft handover, thus reducing an amount of information processing to be performed by the base station. Common data is transmitted to the entire relay devices. Thus, unlike the configuration of FIG. 7, there is no need to transmit the RAI of the second wireless communication channel and transmission data for the terminal to execute a soft handover, individually to a group of relay devices that perform the cooperative transmission. This reduces an amount of resource utilization of the third wireless communication channel for realizing a soft handover. Further, there is no need to select any relay device participating the cooperative transmission, thus improving tracking on movement of the terminal.

Unlike FIG. 9, the base station does not communicate the newly generated transmission signals 902, 903, 904, and 905 of the second wireless communication channel, in the configuration of FIG. 7. A condition of, for example, a geographically distant position causes low communication quality of the second wireless communication channel between the terminal and the relay device. Thus, it is indicated that the transmission signal 902, 903, 904, and 905 may hardly contribute communication quality improvement of the terminal. For the sake of reducing power consumption of the relay device, it is preferred to avoid the transmission of these signals 902 to 905.

### Second Embodiment

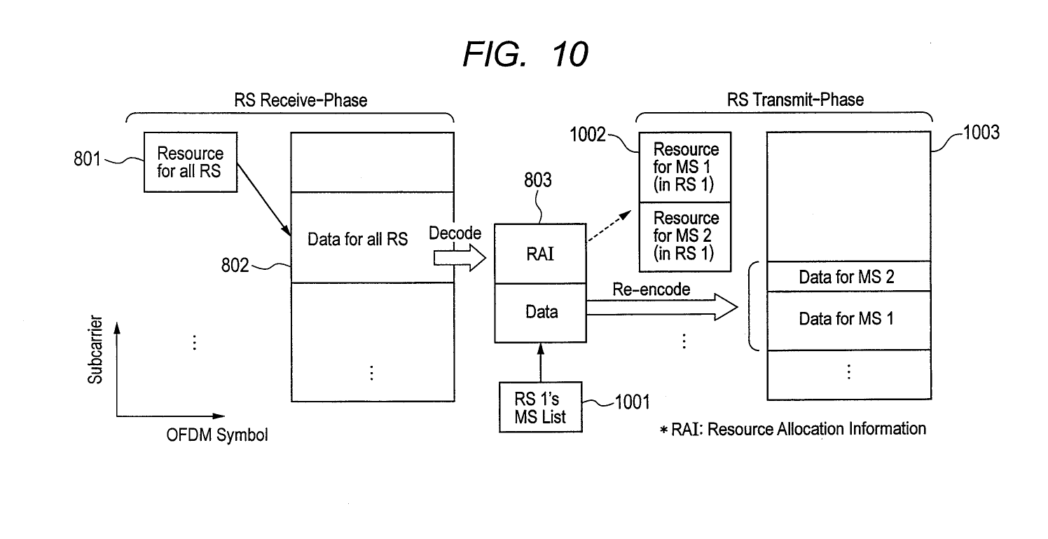

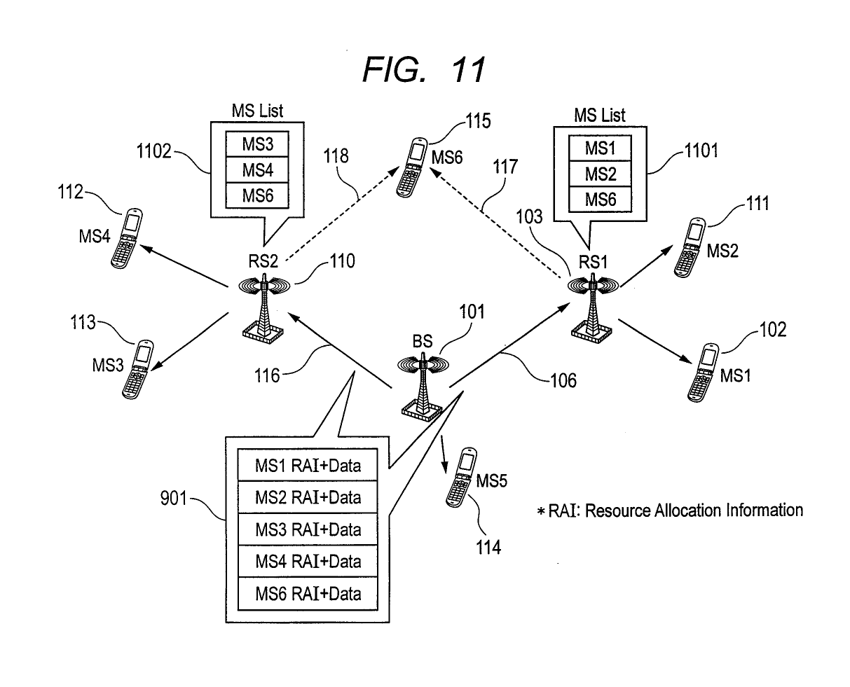

Descriptions will now be made to a second embodiment with reference to FIGS. 10 and 11. The second embodiment avoids transmission of signals that hardly contribute communication quality improvement of the terminal. In addition, it realizes a reduction in occurrence of unnecessary interference in a cell itself and unnecessary interference against another cell(s) and a reduction in power consumption (energy consumption) of each relay device.

In the second embodiment, a list of destination terminals is managed. These listed terminals are destinations to which the relay devices transmit data through the second wireless communication channel. Of the destination terminals of the second wireless communication channel, as represented in the RAI as relay control information of the third wireless communication channel signal 802, only a terminal corresponding to the terminal in the destination terminal list as the relay destination information is selected as a transmission destination to set the second wireless communication channel data signal.

FIG. 10 is to explain a control configuration of this embodiment. FIG. 10 shows an operation of the first relay device 103. The relay device 110 performs the same operation as this device 103. The third wireless communication channel control signal 801, the third wireless communication channel data signal 802, and the information 803 of the second wireless communication channel transmission data are the same as those of FIG. 8. The base station 101 transmits the RAI of the second wireless communication channels 117 and 118 and the transmission data, in association with the entire terminals 102, 111, 112, 113, and 115, to the entire relay devices 103 and 110 through the third wireless communication channels 106 and 116. These entire terminals receive data from the base station through any of the relay devices. The difference from FIG. 8 is that the relay devices 103 and 110 manage the list of destination terminals. The first relay device 103 forms a second wireless communication channel data signal 1003 based a destination terminal list 1001 as relay destination information. A second wireless communication channel data signal 1002 is transmitted in accordance with the same manner as that of the signals 406 and 804.

FIG. 11 shows a state of data transmission in this embodiment. The first difference from the configuration of FIG. 9 according to the first embodiment is that the relay devices 103 and 110 respectively manage destination terminal lists 1101 and 1102, as relay destination information. The second difference is that the inefficient transmission signals 902, 903, 904, and 905 that exist in FIG. 9 are not generated, as a result that the destination terminals of the second wireless communication channels 117 and 118 are selected based on the destination terminal list.

In addition to an effect of reducing an amount of information processing to be executed by the base station and minimizing resource utilization of the third wireless communication channel, as obtained in the first embodiment, this embodiment enables to reduce the possibility of generating unnecessary interference in its cell and unnecessary interference in another cell(s) due to transmission of the transmission signals 902 to 905. Further, according to this embodiment, there is an advantage of minimizing power consumption (energy consumption) in the relay device. In this embodiment, transmission power that is supposed to be allocated to a non-destination terminal is redistributed to a destination terminal, thereby enabling to improve communication quality of the second wireless communication channel.

### Third Embodiment

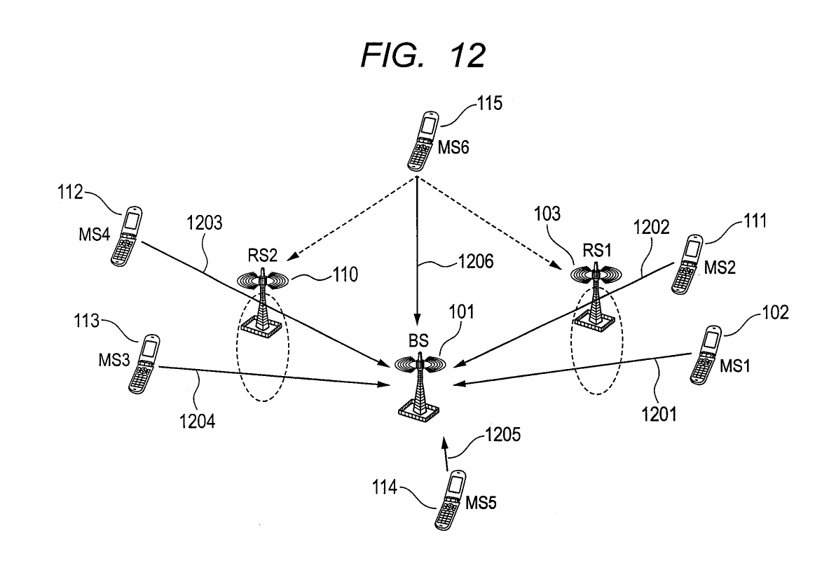

Descriptions will now be made to a third embodiment of the present invention with reference to FIGS. 12 to 15. In particular, the descriptions will be made to a configuration for forming a destination terminal list as relay destination information managed by each relay station of FIG. 11 and a method for forming the list. In this embodiment, an uplink signal transmitted from the terminal to the base station is received also by the relay device. A terminal(s) is selected based on judgment as to whether the received intensity is equal to or greater than a preset threshold value, as a destination terminal(s) in the second wireless communication channel, so as to form the destination terminal list.

FIG. 12 shows a state of data transmission in this embodiment. The terminals 102, 111 to 115 which receive data from the base station 101 send uplink signals 1201 to 1206 to the base station 101, regardless of whether the transmission goes through the relay devices 103 and 110. These signals are intercepted by the relay devices. The received intensity of the received signals is compared with a preset threshold value, thereby achieving detection of a terminal existing within a predetermined distance from the relay device in an autonomous decentralized manner. The signals 1201 to 1206 may be uplink data transmission signals. However, in consideration of tracking on movement of the terminal and stability in proportion to the updating frequency, signals should preferably and periodically be transmitted. For example, in LTE, for the base station to measure communication quality of the uplink, the terminal periodically transmits a pilot signal (reference signal) which is called as an SRS (Sounding Reference Signal). It is preferable to use this signal.

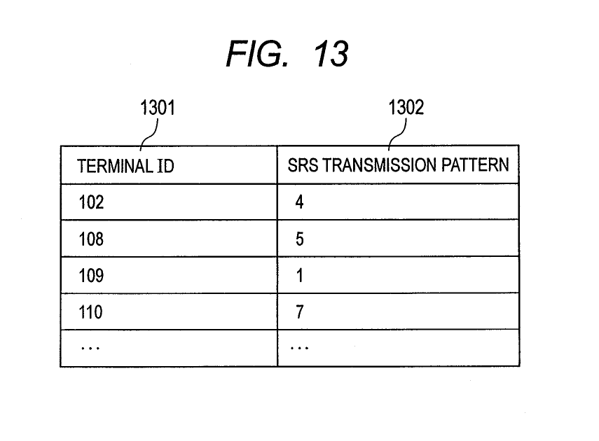

The transmission pattern of the SRS over the uplink corresponds to a terminal ID. The base station measures the communication quality over the uplink communication quality with respect to each terminal, using a list of terminal IDs 1301 and SRS transmission patterns 1302 allocated to the corresponding terminals in association with each other as shown in FIG. 13. The base station informs and shares this list to and with each relay device. As a result, the relay device independently measures the uplink communication quality with respect to each terminal. In WiMAX, the base station measures the uplink communication quality and the downlink communication quality. Thus, the terminal periodically transmits a pilot signal which is called as a Ranging sub-channel. Like the SRS in LTE, the base station manages a corresponding list representing terminal IDs, used resources of Ranging sub-channels (time, frequency), and spreading codes. If this corresponding list is shared with the base station, the relay device independently can measure the quality of uplink communication quality with respect to each terminal using the Ranging sub-channel.

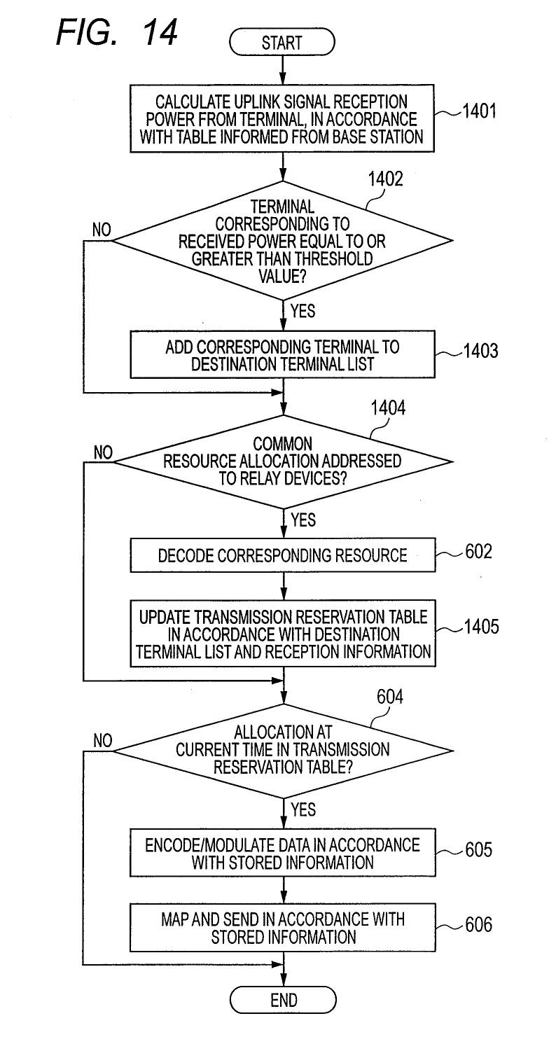

FIG. 14 shows a flowchart of an operation of the relay device according to this embodiment, in LTE. The relay device measures received intensity of an SRS as a reference signal transmitted by each terminal in the relay station, using the corresponding list of the terminal IDs and SRS transmission patterns that is informed from the base station (1401). Next, the relay device compares the measured received intensity of the SRS with a preset threshold value (1402), and adds any terminal corresponding to the SRS whose received intensity is greater than the threshold value, into the destination terminal list of the second wireless communication channel (1403). The threshold value used in the comparison operation 1402 may be acquired, for example, by the base station informing the entire relay devices using the destination ID common to the relay devices. For a reception process of the third wireless communication channel and a transmission process of the second wireless communication channel, steps 602, 604 to 606 of FIG. 14 are the same as those of FIG. 6. There are two differences. One difference (1404) is that a reference for demodulating the third wireless communication channel is changed to a judgment as to whether there is a resource allocated based on an ID common to the relay devices. Another difference (1405) is that the relay device adds only a terminal(s) in its managing destination terminal list to the reception data buffer, of the received RAI of the second wireless communication channel and the transmission data.

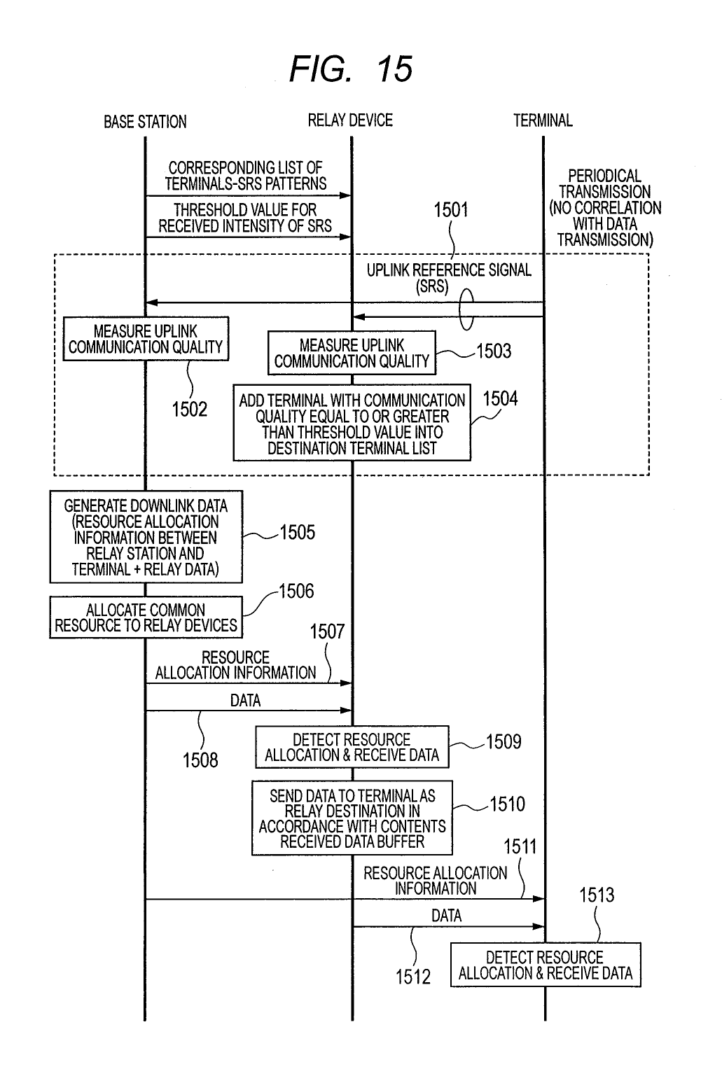

FIG. 15 shows the entire operational sequence, when the above-described third embodiment is used. The terminal periodically transmits the SRS to the base station in accordance with a specified transmission pattern (1501), and the base station measures uplink communication quality based on the received intensity (1502). Similarly, the relay device independently measures the received intensity of the relay device, based on the corresponding list of the terminal IDs and the transmission patterns that are informed from the base station (1503), and adds a terminal(s) corresponding to the intensity equal to or greater than a threshold value into the destination terminal list of the second wireless communication channel (1504). Operations of steps 1501 to 1504 are performed independently from downlink transmission operations of the base station. Operations of the relay station from step 1503 to 1504 correspond to the flow from 1401 to 1403 in FIG. 14.

When downlink data transmission is performed through the relay device, the base station first generates resource allocation information of the second wireless communication channel and transmission data of the second wireless communication channel (1505), generates resource allocation information of data using the ID common to the relay devices (1506), sends the resource allocation information of the second wireless communication channel which has been generated in 1505 and transmission data of the second wireless communication channel to the relay device, using a resource allocated in 1507 (1507, 1508). The relay device detects generation of resource allocation and the transmitted resource, based on the resource allocation information (RAI) 1507, and performs a reception operation (1509). An operation of the relay station in step 1509 corresponds to the flow from 1404 to 602 in FIG. 14. After the flow of 1405 and 604 in FIG. 14, of information representing transmission of the second communication channel represented in the received data, only a terminal corresponding to the destination terminal list created in step 1504 is selected, and a transmission signal of a second communication channel data signal 1512 is generated (1510). An operation of the relay station in station 1510 corresponds to the flow of 605 to 606 in FIG. 14. The terminal detects generation of resource allocation and the transmitted resource, based on the resource allocation information (RAI) 1511 of the second wireless communication channel which is transmitted by the relay device or the base station, and performs a reception operation (1513).

In this embodiment, the terminal creates the destination terminal list based on an uplink signal to be transmitted to the base station. As a result, it is possible to prevent the relay station from data transmission in an autonomous decentralized manner toward a terminal at a distance equal to or greater than a predetermined distance from the relay device, that is, data transmission for a relay device. This data transmission hardly contributes reception quality improvement of the terminal. The signals 1201 to 1206 may be pilot signals from the terminals, thus improving tracking on movement of the terminal and stability in proportion to the updating frequency.

The descriptions have been made to the example of LTE in FIGS. 14 and 15. The same configuration can be realized with other standards, such as WiMAX, etc. FIGS. 12 to 15 show examples in which the relay device forms the destination terminal list based on the received intensity of the uplink pilot signal (reference signal). However, the terminal may observe an Acknowledge Channel for feeding back reception success or failure information (ACK signal, NACK signal) regarding the downlink data signal, and the base station may perform a process for adding a terminal which has not performed a retransmission process for the reception success or failure (that is, a terminal with a possibility in which the uplink control signal of the ACK signal may not reach the base station) into the destination terminal list. That is, the reception success or failure regarding the downlink data signal with respect to the terminal is observed. This configuration realizes an effect of improving the possibility of adding the terminal with low quality of the first wireless communication channel (that is, the terminal requiring the relay by the relay device) into the destination terminal list. It realizes another effect of improving the possibility of not adding the terminal with fair quality of the first wireless communication channel (that is, the terminal not requiring the relay by the relay device) into the destination terminal list.

### Fourth Embodiment

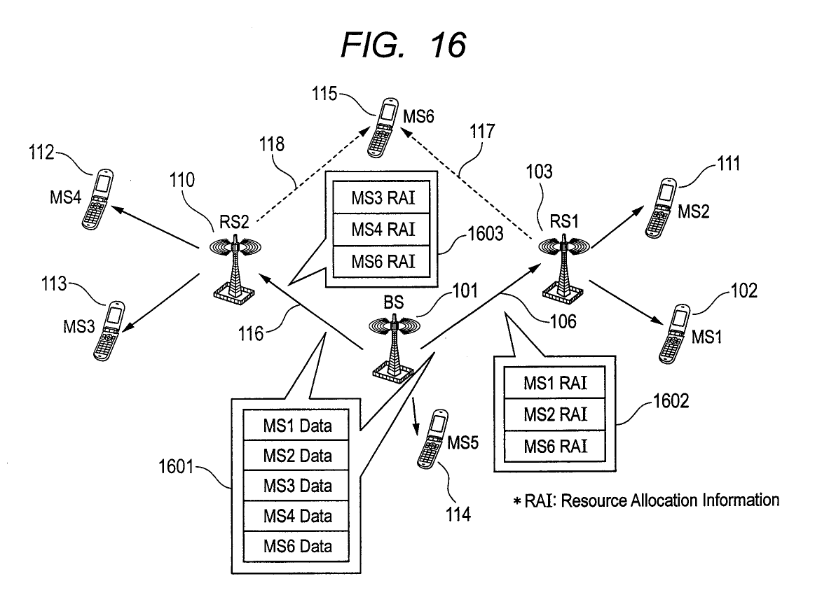

The descriptions have been made to the embodiment in which the relay device observes the received intensity of the uplink signal sent by the terminal, and manages the destination terminal list of the second wireless communication channel in an autonomous decentralized manner. However, to simplify the configuration of the relay device, the base station may manage the destination terminal list as the relay destination information. This can be realized based on a comparison between, for example, location information of the terminal and location information of the relay station. For example, in LTE, according to a proposed system, the base station understands the location of the terminal using an OTDOA (Observed Time Difference Of Arrival) technique. If the relay device is a fixed device, the base station can understand its location based on information at the time the device is introduced. If the relay device is a mobile device, the base station can understand the location in accordance with the same system. Thus, the relay device calculates the geographical distance between, for example, the terminal and each relay device, adds a terminal with the geographical distance equal to or lower than a threshold value into the destination terminal list of the relay device. As a result, the base station can form the destination terminal list as the relay destination information representing the relay devices. At this time, a threshold value regarding the distance for judging whether a corresponding relay device should be a belonging relay device may be changed based on quality information of the first wireless communication channel through which the terminal feeds back information to the base station. It improves the possibility of adding a terminal with low quality of the first wireless communication channel, that is, a terminal requiring relay by the relay device. It also improves the possibility of not adding a terminal with fair quality of the first wireless communication channel, that is, a terminal not requiring relay by the relay device, into the destination terminal list. In this case, the base station informs the relay station of the formed destination terminal list as relay destination information, thereby enabling to realize selection transmission in an autonomous decentralized manner as shown in the above-described embodiment or to apply the configuration of FIG. 16.

In the configuration of FIG. 16, the base station 101 transmits only transmission data 1601 of the second wireless communication channels 117 and 118 using an ID common to the relay devices 103 and 110, in the third wireless communication channels 106 and 116. Further, the base station transmits resource allocation information (RAI) 1602 and 1603 of the second wireless communication channel using individual IDs respectively to the relay devices 101 and 110 as relay control information. Of the received transmission data 1601 of the second wireless communication channel, the relay devices 103 and 110 transmit only data of destination terminals represented in the resource allocation information (RAI) 1602 and 1603 through the second wireless communication channels 117 and 118.

When this embodiment is applied, the base station 101 has information for judging whether a soft handover state is necessary, and needs to perform the judgment, in association with the entire terminals for performing data reception through the relay device. However, as compared with the embodiment of FIG. 7, the signal repeatedly transmitted through the third wireless communication channels 106 and 116 includes only the resource allocation information (RAI) as relay control information, thus improving resource utilization efficiency. Though it is necessary in the second embodiment of FIG. 11, it is not necessary that the relay device itself manages and updates the destination terminal list as relay destination information, resulting in an advantage of easily forming the relay device.

### Fifth Embodiment

In the above-described embodiments, the common ID is used for the entire relay devices. This realizes collective transmission of data of the entire terminals which receive data through any of the relay devices. As a result, there is no need to select any relay device participating the cooperative transmission, thus improving tracking on movement of the terminal. However, for the entire relay devices to receive data, it is necessary to perform transmission with MCS in conformity with the relay device with the lowest communication quality of the third wireless communication channel, thus possibly increasing the frequency resource necessary for the third wireless communication channel. This problem can be addressed by grouping the relay devices located geographically near to each other, gathering only data of belonging terminals of a group, and transmitting a common ID to the group.

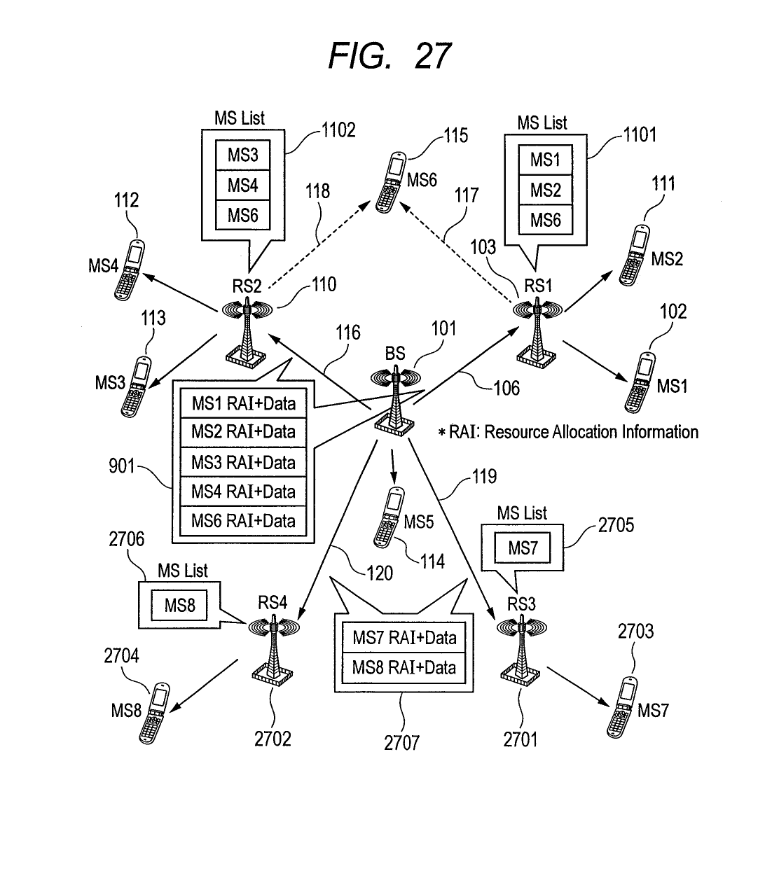

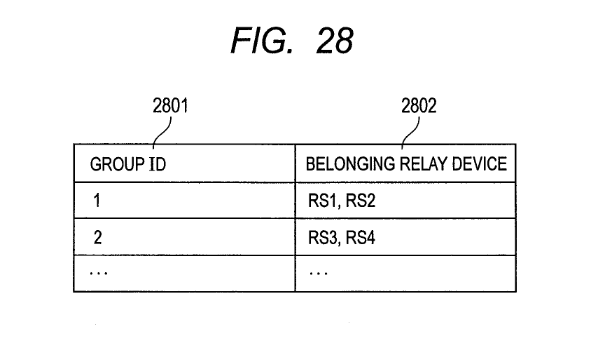

In a fifth embodiment, descriptions will be made to a configuration of FIG. 27, in which the relay devices are grouped and have a common ID affixed thereto, and only data of the belonging terminals of each group is gathered so as to be transmitted. FIG. 27 shows a case in which a third and fourth relay devices 2701 and 2702 exist, and in which a seventh and eighth terminals 2703 and 2704 are included respectively in destination terminal lists 2705 and 2706, in the first embodiment shown in FIG. 11. The first and second relay devices 103 and 110 are geographically near to each other, and the third and fourth relay devices 2701 and 2702 are geographically near to each other. These groups are located far from each other. At this time, the base station forms a group 2802 of two relay devices as shown in FIG. 28, and shares the corresponding information with the relay devices. Then, the station gathers data of terminals belonging to either relay device corresponding to its belonging group, and performs transmission through the third wireless communication channels 106, 116, 119, and 120, using a corresponding group ID 2801, like 901 and 2707.

In this embodiment, the transmission data 901 of the third wireless communication channels 106 and 116 does not include in advance data corresponding to terminals (e.g. the terminals 2703 and 2704 corresponding to the relay device 103) located far from the relay device. Thus, as compared to the first embodiment, each relay device needs to receive only a smaller amount of data of the third wireless communication channel. The geographically closed relay devices are grouped, thereby homogenizing the communication quality of the third wireless communication channel in the group. This reduces the possibility of inefficient MCS selection occurred in the first embodiment. For a terminal which executes a soft handover between the relay devices belonging to a plurality of groups, data of the terminal needs to repeatedly be transmitted to the plurality of groups. This deteriorates resource utilization efficiency of the third wireless communication channel as compared to the first embodiment. Because the group participating the cooperative transmission is selected, tracking on movement of the terminal is deteriorated as compared to the first embodiment. In this embodiment, the geographically closed relay devices are grouped. However, the relay devices with similar communication quality of the third wireless communication channel may be grouped, based on the fed back information from the relay device to the base station.

According to the above-described embodiments, it is possible to restrain loss of system performance by introducing the relay devices and to enhance the performance gain. For example, it is possible to enhance the average spectral efficiency of the cell.

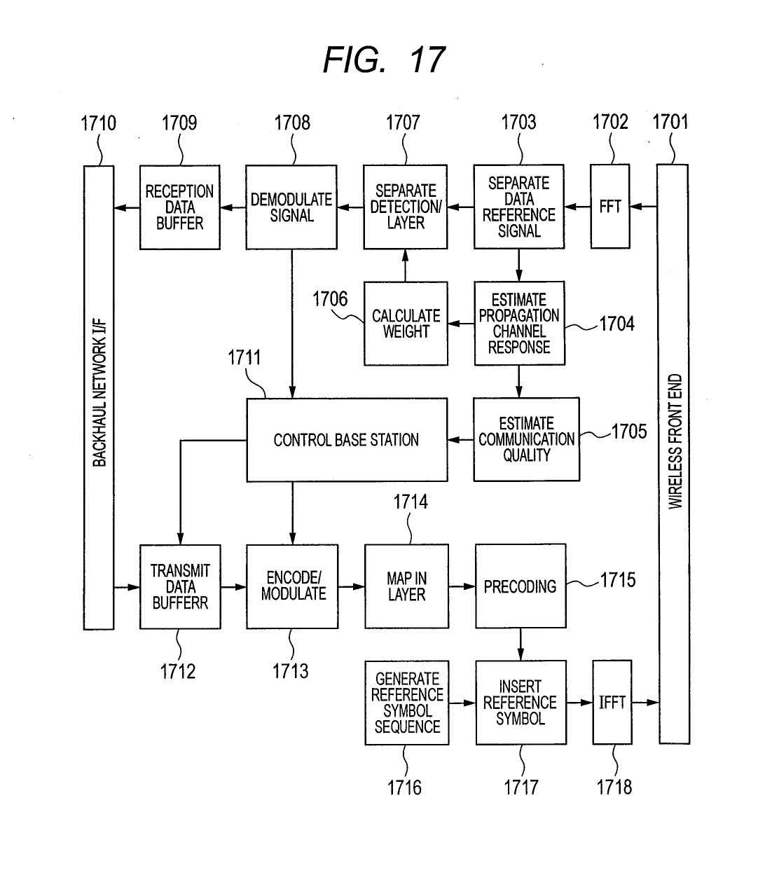

The descriptions have so far been made to various embodiments. Descriptions will now be made to a specific embodiment of a base station, a relay device, and a terminal, in a wireless communication system which performs wireless communication using a wireless system, such as an OFDM (Orthogonal Frequency Division Multiplexing) system, in each of the above-described embodiment, with reference to FIGS. 17 to 21.

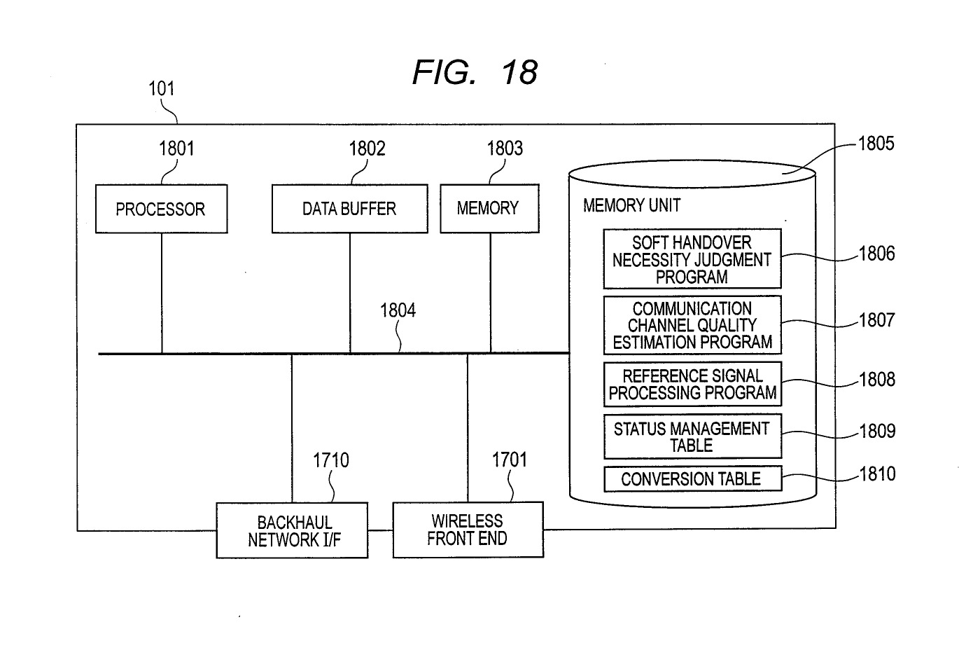

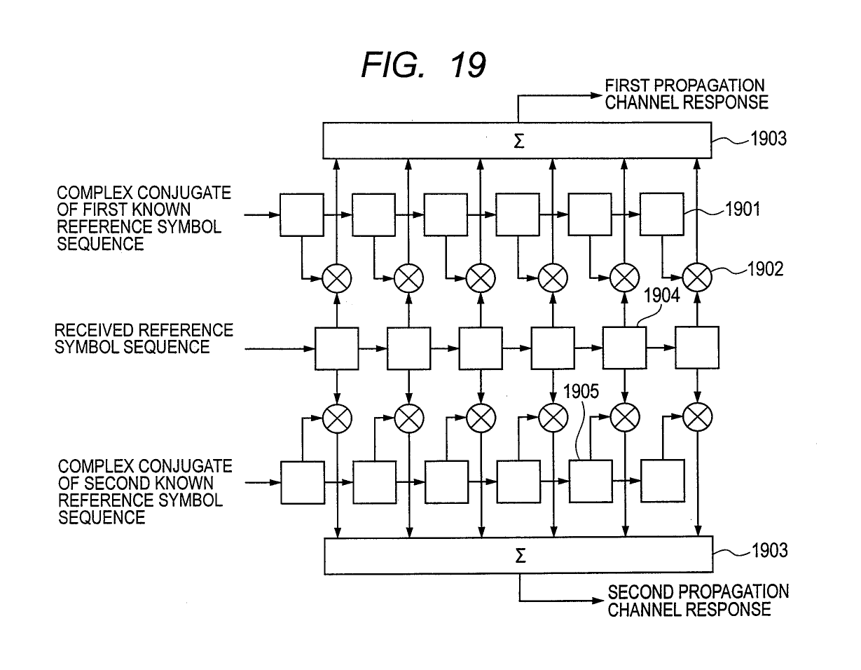

FIG. 17 shows an example of a functional block configuration of a base station, and FIG. 18 shows an example of a device configuration of a base station. In this specification, except a wireless front end 1701 and blocks 1709 and 1712 identifying buffers, those functional blocks are expressed as a “function”, a “unit”, and a “block”, such as a “demodulation/decoding function”, a “demodulation decoding unit”, and a “demodulation decoding block”.

In FIG. 17, the wireless front end 1701 includes a normal antenna, a duplexer, a power amplifier, a low noise amplifier, an up-converter, a down-converter, an analog-digital converter, and a digital-analog converter. The wireless front end 1701 transmits and receives a wireless frequency signal. An uplink received based-band signal is FFT-processed by an FFT unit 1702. A data symbol and a reference signal symbol are formed by a data reference signal separator 1703 as a result of the separation.

A propagation channel response estimator 1704 performs response estimation for the reference signal symbol formed by the data reference signal separator 1703, over the uplink first wireless communication channel and the uplink third wireless communication channel. The estimation of the propagation channel response applies a known reference signal symbol on both transmission/reception sides (between terminal and base station, and between relay device and base station). If the reference signal symbol does not change with time, the propagation channel response estimator 1704 keeps a fixed and known reference symbol sequence in a storage unit (e.g. a memory unit 1805 of FIG. 18, as will be described later). If the reference signal symbol changes with time, the propagation channel response estimator 1704 generates a reference signal symbol sequence, in accordance with a rule of a reference signal symbol sequence shared by the transmission side and the reception side.

A plurality of reference signal symbol sequences with low cross correlation may be multiplexed at the same time and into the same frequency, that is, different reference signal symbol sequences may be transmitted at the same time and in the same frequency between terminals, between relay devices, or between a terminal and a relay device. In this case, as shown in FIG. 19, the received reference signal sequence is stored in a middle register 1904 such that the head symbol comes at the right side, the complex conjugate of the first known reference symbol sequence is stored in an upper register 1901 such that the head symbol comes at the right side, and the complex conjugate of the second known reference symbol sequence is stored in a lower shift register 1905 such that the head comes at the right side.

In this state, as illustrated, adders 1903 and multipliers 1902 execute addition and multiplication, thereby acquiring a propagation channel response for first reference signal symbols and a propagation channel response for second reference signal symbols. In this case, the received reference signal symbol sequence is input from the data reference signal separator 1703. The known first reference signal symbols and second reference signal symbols are input from a storage unit for storing a fixed sequence used by the propagation channel response estimator 1704. Alternately, the input corresponds to a result generated in accordance with a rule of the reference signal symbol sequence and shared between the transmission side and the reception side in the propagation channel response estimator 1704.

A communication quality estimation processing unit 1705 estimates an uplink first wireless communication channel, an uplink third wireless communication channel, and their communication quality, based on a propagation channel estimation result of the propagation channel response estimation unit 1704. The estimation over the first wireless communication channel corresponds to the uplink communication quality measurement of FIG. 15 (1502). In the easies method of the communication quality measurement, noise power and interference power are assumed as fixed values, the square of the result of the propagation channel estimation that is made by the propagation channel response estimator 1704 is assumed as a predetermined signal power, and a value obtained by dividing the predetermined signal power by a fixed value is handled as SINR (Signal to Interference plus Noise Ratio). This ratio is converted into Shanon capacity. According to this method, the estimation of the communication quality is miscalculated, when the above assumption was wrong in fact, thus likely to perform outer loop control. In this case, data communication is repeated using a fixed value which has been set based on expectation that a packet error ratio of the data sequence will be a certain value (e.g. 1%, 0.1%). When the actual packet error ratio is greater than an expected value, it is assumed that the sum of the actual noise power and the interference power is greater than the fixed value. Thus, a high fixed value is set. On the contrary, when the ratio is lower than an expected value, it is assumed that the sum of the actual noise power and the interference power is lower than the fixed value. Thus, a low fixed value is set.

The communication quality estimator 1705 estimates communication quality of the uplink first wireless communication channel and communication quality of the third wireless communication channel, and inputs the estimated quality to a base station control block 1711.

A weight calculator 1706 calculates a receive weight using a result of the propagation channel estimation by the propagation channel response estimator 1704. The object of the receive weight is to separate a plurality of received spatial layers and to perform phase correction of the spatial layers. Known algorithms of the receive weight calculation include ZF (Zero Forcing), MMSE (Minimum Mean Square Error), and the like.

A detection/layer separator 1707 multiplies a data symbol vector of the plurality of spatial layers separated by the data reference signal separator 1703 by a receive weight matrix calculated by the weight calculator 1706, separates the spatial layers, and perform phase correction for the spatial layers.

A demodulation/decoding unit 1708 gathers data symbols divided into spatial layers by the detection/layer separator 1707 in the unit of code words, obtains a log likelihood ratio for each bit, and performs Turbo decoding or Viterbi decoding. Of the decoded results, the data part is stored in a reception data buffer 1709, and control information is input to the base station control block 1711. This control information includes communication quality of the downlink first wireless communication channel fed back by the terminal, communication quality of the second wireless communication channel fed back by the terminal, communication quality of the downlink third wireless communication channel fed back by the relay device, and communication quality of the uplink second wireless communication channel fed back by the relay device. In addition, when the base station judges whether to perform a soft handover like the first embodiment and the fourth embodiment, the control information further includes information including location information of the terminal which is used for the judgment. The control information is input to the base station control block 1711 through this route. A difference between the data and the control information can be made in accordance with a protocol of a wireless I/F that is issued by a standardization organization, in conformity to the corresponding wireless communication system.

A backhaul network I/F 1710 is an I/F for a backhaul network connected in wire to a node (e.g. access gate way) of an upper level than the base station. The backhaul network I/F 1710 stores data in a transmission data buffer 1712. This data is forwarded to/from an upper level node of the reception data buffer 1707.

The base station control unit 1711 performs uplink packet scheduling, performs downlink packet scheduling, and judges necessity of a soft handover for each terminal in a fourth embodiment, based on an estimated result of communication quality obtained by the communication quality estimator 1705 and feedback information obtained from the relay device or terminal by the demodulation/decoding unit 1708. A known algorithm of the packet scheduling includes a proportional fairness algorithm. When the proportional fairness algorithm is applied in the above-described embodiments, a transmission rate is calculated in a moment, based on communication quality of the second wireless communication channel for the terminal performing transmission through the relay device and based on communication quality of the first wireless communication channel for the terminal performing direct reception from the base station. The result of the packet scheduling of the first wireless communication channel or third wireless communication channel is input to an encoding/modulation unit 1713 as a downlink control signal. An instruction is made to input the resource allocation information (RAI) of the second wireless communication channel to the transmission data buffer 1712, so as to generate transmission data of the third wireless communication channel (as shown in FIG. 5) in combination with corresponding transmission data. Finally, the base station control unit 1711 instructs the encoding/modulation unit 1713 to retrieve a data sequence from the transmission data buffer 1712, in accordance with a result of downlink packet scheduling.

The encoding/modulation unit 1713 encodes and modulates a data sequence from the transmission data buffer 1712 and a control information sequence from the base station control unit 1711. In the encoding, a convolutional encoder with an original encoding rate of ⅓ is used. A series of bit sequences which have been output are called a “code word”. The modulation includes tying up two bits of the encoded output, tying up four bits of the output, and tying up six bits of the output, thereby respectively realizing QPSK constellation mapping, 16QAM constellation mapping, and 64QAM constellation mapping. The number of bits to be tied up together is based on the downlink scheduling result from the base station control unit 1711 and a protocol.

A layer map unit 1714 performs a process for mapping a modulation symbol sequence into a plurality of spatial layers. This modulation symbol sequence is to form a code word output as a result of the encoding by the encoding/modulation unit 1713. Each modulation symbol is arranged in a particular OFDM symbol, a sub-carrier, and a spatial layer. The arrangement rule is defined in the protocol. Thus, the arrangement target is specified with reference to the storage unit (e.g. the memory unit 1805 of FIG. 18) which stores throughout the arrangement location in accordance with the rule or based on a logic circuit which has an algorithm for the arrangement rule. The above-described arrangement is made without the OFDM symbol in which a reference signal symbol is stored, a sub-carrier, and a spatial layer. At this stage, the location in which the reference signal symbol is stored is blank. The blank symbol includes an “I” component and a “Q” component that are both 0.

A pre-coding processing unit 1715 performs a process for multiplying a pre-coding matrix as a transmission weight matrix, when a layer map output corresponding to the plurality of spatial layers of 1714 is handled as a vector. The pre-coding processing unit 1715 executes this process for the entire OFDM symbols and sub-carriers. At this stage also, the location in which the above-described reference symbol is stored is blank.

A reference symbol sequence generation unit 1716 is a block for generating a downlink reference signal symbol sequence. The reference signal symbol sequence may preferably be a BPSK symbol sequence, a QPSK symbol sequence, or a Zadoff-Chu sequence. In this case, the BPSK symbol sequence has been generated based on an M sequence with low cross correlation between reference signal symbol sequences, a PN sequence, a Walsh sequence. There are well-known algorithms for generating various sequences. The algorithms may be realized using a logic circuit, or may be realized by looking up a table stored in a memory (the memory unit 1805 of FIG. 18) in which outputs of the entire generated sequences are stored in advance.

A reference symbol insertion processing unit 1717 inserts a reference signal symbol sequence generated by the reference symbol sequence generation unit 1716, into a part of the blank symbol in the pre-coding output of the pre-coding unit 1715. Upon completion of this insertion process, an IFFT process is executed for each OFDM symbol by 1718, and is output to the wireless front end 1701.

Those parts, except the wireless front end 1701 and the backhaul network I/F 1710, can be realized by a logic circuit as the hardware included in the base station or a processor as a processing unit including a DSP (Digital Signal Processor), an MPU (Micro Processing Unit), or the like.

FIG. 18 is a diagram showing an embodiment of a device configuration of the base station 101. The base station 101 includes a processor 1801 as a processing unit, a data buffer 1802 and a memory 1803 as storage units, which are connected with each other through an internal bus 1804. Further, the station includes the backhaul network I/F 1710 and the wireless front end 1701 as network I/Fs, and has the memory unit 1805 as a storage unit for storing programs or tables.

The memory unit 1805 stores a soft handover necessity judgment program 1806, a communication channel quality estimation program 1807, a reference signal processing program 1808, a status management table 1809, and a conversion table 1810. The programs are stored in the memory 1803 as needed, and are executed by the processor 1801 as a processing unit. The programs corresponding to the processing of the base station disclosed in this description may not be shown in the illustration.

The communication channel quality estimation program 1807 corresponds to the communication quality estimator 1705 of FIG. 17. The reference signal processing program 1808 corresponds to a process executed by the reference symbol sequence generation unit 1716 and the reference symbol insertion unit 1717 of FIG. 17.

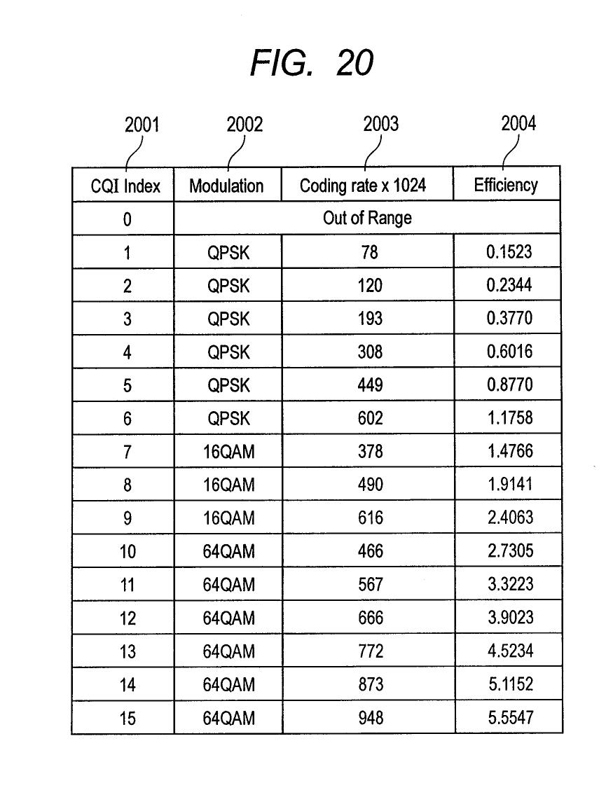

The status management table 1809 manages a list of destination terminals of the second wireless communication channel in association with each relay device. The conversion table 1810 is a conversion table that shows an example that is referred when obtaining the communication channel quality. This example is shown in FIG. 20. In FIG. 20, rows 2001, 2002, 2003, 2003, and 2004 respectively correspond to “CQI Index”, “Coding Rate (×1024)”, and “Efficiency”, and show a conversion table from the wireless communication channel quality (CQI) to capacities.

The processor 1801 executes the programs stored in the memory unit 1805. The processor 1801 executes a process corresponding to a base station control block of FIG. 17, and refers to the table to control the wireless communication.

Needless to say, the data buffer 1802 corresponds to the reception data buffer 1709 or transmission data buffer 1712 of FIG. 17. The memory 1803 keeps the above-described developed programs to be processed by the processor 1801 and data necessary for the process.

The wireless front end unit 1701 is an interface for transmitting/receiving a wireless signal to/from the relay device and the terminal device, like FIG. 17. The backhaul network I/F is an interface for connecting between other base stations or connecting to a node of an upper level than the base station, like FIG. 17.

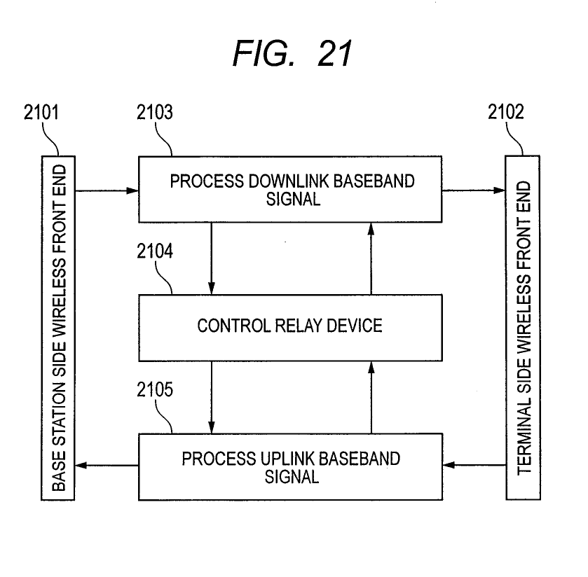

FIG. 21 shows an embodiment of a specific configuration of the relay device.

A reference numeral 2101 identifies a base station-side wireless front end, while a reference numeral 2102 identifies a terminal-side wireless front end. The constituent elements are the same as those of the wireless front end 1701 of FIG. 17.

A downlink baseband signal processing unit 2103 decodes a downlink baseband signal input from 2101, and inputs decoded data to a relay device control block 2104. Further, the unit receives inputs of downlink resource allocation information (RAI) of the second wireless communication channel and transmission data from the relay device control block 2104, encodes the transmission data, and outputs it to the terminal side wireless front end 2102.

An uplink baseband signal processing unit 2105 decodes an uplink baseband signal input from the terminal-side wireless front end 2102, and inputs decoded data to the relay device control block 2104. Further, the unit receives inputs of uplink resource allocation information (RAI) of the second wireless communication channel and transmission data from the relay device control block 2104, encodes it, and outputs it to the base station-side front end 2101.

The relay device control block 2104 is the main constituent for the operation of the relay device which is shown in FIG. 6A and FIG. 14. In the second embodiment, the block manages a corresponding table of terminal IDs and SRS transmission patterns, a destination terminal list of the second wireless communication channel, and a transmission reservation table. The block measures the received intensity of SRSs transmitted by the terminal, and updates the destination terminal list based on the measurement. The block updates the reception data buffer based on the received signals input from the baseband signal processing units 2103 and 2105 and the destination terminal list. Further, the block inputs the resource allocation information (RAI) of the second wireless communication channel and transmission data information based on the reception data buffer to the baseband signal processing units 2103 and 2105, and sends an instruction to transmit the information. In this third embodiment, of the above-described operations, updating of the destination terminal list is not necessarily. In this first embodiment, the destination terminal list itself is not necessary.

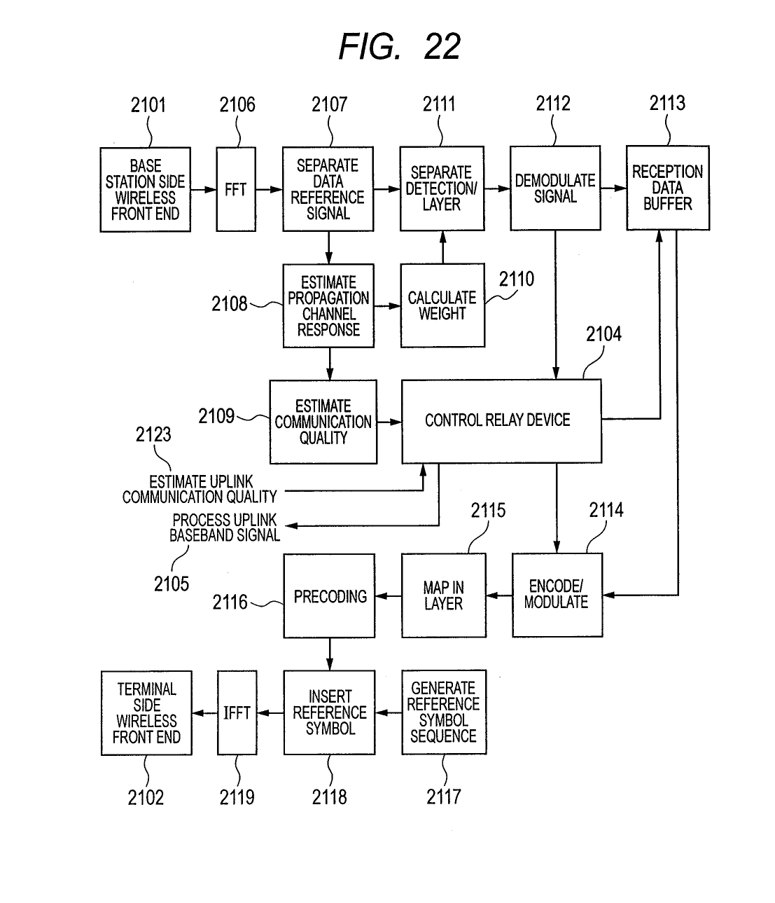

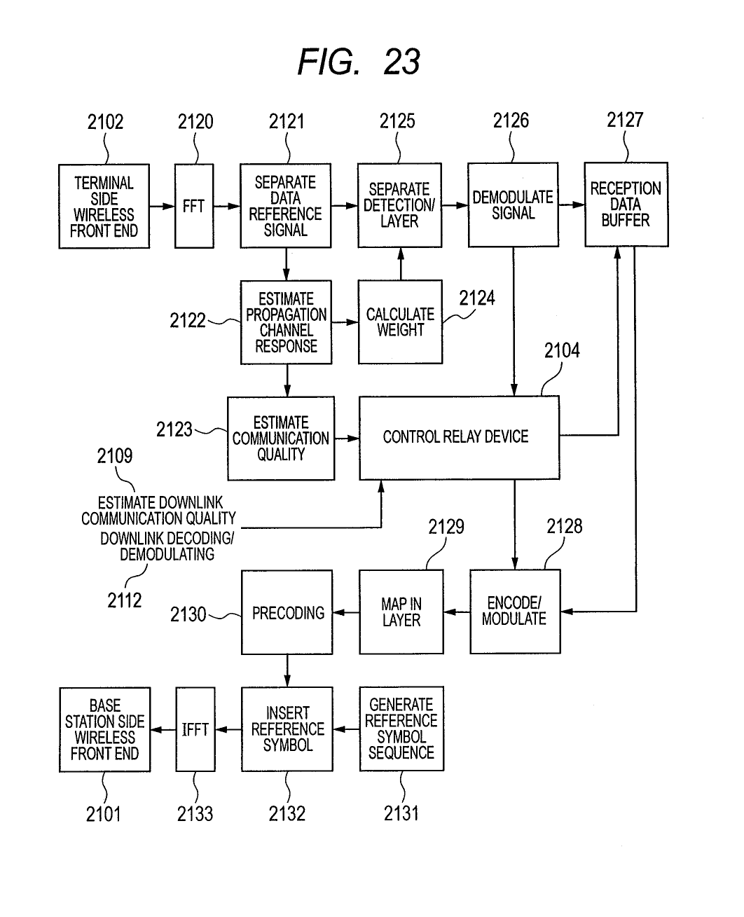

FIG. 22 shows an example of a functional block configuration regarding downlink communication in the relay device of this embodiment. In FIGS. 22 and 23, functional blocks except blocks 2113 and 2127 identifying buffers are expressed as a “function”, a “unit”, and a “block”, for example, a “demodulation/decoding function”, a “demodulation/decoding unit”, and a “demodulation/decoding block”.

An FFT unit 2106 performs an FFT process for a downlink reception signal baseband signal input from the base station-side wireless front end 2101. A data reference signal separator 2107 separates a signal to obtain a data symbol and a reference signal symbol.

A propagation channel response specifying unit 2108 estimates a response over a downlink third wireless communication channel for the reference signal symbol obtained by the data reference signal separator 2107. Like the block 1704 in the base station of FIG. 17, estimation of the response over the propagation channel uses a known reference signal symbol on both of the transmission side and the reception side (the base station and the relay device). If the reference signal symbol does not change with time, a fixed and known reference signal symbol sequence is kept in the memory. If the reference signal symbol changes with time, a reference signal symbol sequence is generated in accordance with a rule of the reference signal symbol sequence that is shared between the transmission side and the reception side.

A communication quality estimator 2109 estimates communication quality of a downlink third wireless communication channel based on a result of the propagation channel estimation by the propagation channel response estimation unit 2108. A specific method for estimating communication quality is the same as the block 1705 of FIG. 17. The obtained estimated result is input to the relay device control block 2104.

Blocks 2110 and 2111 are the same as those blocks 1706 and 1707 of FIG. 17.

A demodulation/decoding unit 2112 gathers the data symbols which have been divided into spatial layers by a detection/layer separator 2111 in the unit of code words, obtains a log likelihood ratio for each bit, and performs Turbo decoding or Viterbi decoding. The decoded result is made in a format of FIG. 5, and is generally stored once in a downlink reception data buffer 2113. Information of a destination terminal ID is input to the relay device control block 2104.

The relay device control block 2104 internally keeps the destination terminal list of the second wireless communication channel, as identified by 1101 and 1102. A downlink communication process includes an instruction process, a relay control process, and an updating process. The instruction process is to instruct the uplink baseband processing unit 2105 to transmit communication quality of the downlink third wireless communication channel which has been estimated by the communication quality estimator 2109, as a control signal. The relay control process is to input destination terminal information of the second wireless communication channel from the demodulation/decoding unit 2112 and to instruct an encoding/modulation unit 2114 to perform encoding for only a data sequence to be relayed, in accordance with a result of collating the internally managed destination terminal list of the second wireless communication channel. The updating process is to update the internally managed destination terminal list of the second communication channel based on an estimated result 2123 of the uplink communication quality which has been input from the uplink baseband processing unit 2105. The descriptions have been made to the configuration in which the relay device control block 2104 internally keeps the destination terminal list. However, instead of the relay device control block 2104, the reception data buffer 2113 may keep the destination terminal list, and the relay device control block 2104 may refer to and update the destination terminal list kept in the reception data buffer 2113.

Of a third wireless communication channel data signal transmitted in the format of FIG. 5 from the base station, the relay device extracts a field for the destination terminal ID of the second wireless communication channel, collates the field with the destination terminal list of the second wireless communication channel, and controls to perform a process from the re-encoding of only a data sequence addressed to a terminal performing the relay. The data sequence not to be relayed is cleared from the downlink reception data buffer 2113.

The encoding/modulation unit 2114 encodes and modulates a data sequence from the downlink reception data buffer 2113 in accordance with control information peculiar to the same data sequence. In this embodiment, an example of this target data sequence is one instructed from the relay device control block 2104.

The contents of a process performed by a layer mapping unit 2115 are the same as those of the encoding/modulation unit 2114. Further, a modulation symbol is arranged on a sub-carrier or OFDM symbol represented in control information peculiar to the data sequence.

A pre-coding unit 2116 performs a process for multiplying a pre-coding matrix as a transmission weight matrix, while handling a plurality of spatial layers of a layer map output of the layer mapping unit 2115 as a vector. The pre-coding unit 2116 performs this process for a target OFDM symbol for transmission and a target sub-carrier for transmission.

A reference symbol sequence generation unit 2117 is a block for generating a downlink reference signal symbol sequence. The same reference signal symbol sequence as that generated by the reference symbol sequence generation unit 1716 may be generated. However, if reference signal symbols are set to overlap each other in the OFDM symbol and the sub-carrier that are the same as the reference signal symbol sequence of the base station, another sequence having cross correlation as low as possible is used. The method for generating the reference signal symbol sequence is the same as that of 1716.

A reference symbol insertion unit 2118 performs a process for inserting a reference signal symbol sequence generated by the reference symbol sequence generation unit 2117 into a part corresponding to a blank symbol in the pre-coding output of the pre-coding unit 2116. Upon completion of this insertion process, an IFFT unit 2119 performs an IFFT process for each OFDM symbol, and outputs it to the terminal side wireless front end 2102.

Functional blocks, except the above-described wireless front ends 2101 and 2102, can be realized using a logic circuit as the hardware of the relay device or a processor as a processing unit, such as a DSP, MPU, etc.

FIG. 23 is a diagram showing an example of an embodiment of an uplink communication process of the relay device.

An FFT unit 2120 performs an FFT process for an uplink reception baseband signal input from the terminal side wireless front end 2102. This signal is separated into a data symbol and a reference signal symbol by a data reference signal separation unit 2121.

A propagation channel response estimator 2122 estimates a response over an uplink second wireless communication channel, for the reference signal symbol obtained by the data reference signal separator 2121. Like a block 1704, known reference signal symbols are used for both of the transmission and reception sides (terminal and relay device). If the reference signal symbol does not change with time, a fixed and known reference signal symbol sequence is kept in the memory. If the reference signal symbol changes with time, a reference signal symbol sequence is generated in accordance with a rule of the reference signal symbol sequence shared between the transmission side and the reception side.

A communication quality estimator 2123 estimates communication quality over an uplink second wireless communication channel, based on an estimated result of the propagation channel by the propagation channel response estimator 2122. A specific method for estimating communication quality is the same as the block 1705. The obtained estimated result is input to the relay device control block 604.

Blocks 2124 and 2125 are respectively the same as the blocks 1706 and 1707 of FIG. 17.

A decoding/demodulation unit 2126 gathers data symbols, which have been divided into spatial layers by the detection/layer separator 2125, in the unit of code words, obtains a log likelihood ratio for each bit, and performs Turbo decoding or Viterbi decoding. Of a decoded result, a data part is stored in an uplink reception data buffer 2127, and control information is input to the relay device control block 2104. A difference between the data and the control information can be made in accordance with a protocol of a wireless I/F that is issued by a standardization organization, in conformity to the corresponding wireless communication system.

The relay device control block 2104 performs a process for embedding communication quality of the uplink second wireless communication channel which is input from the communication quality estimator 2123 and communication quality of the downlink third wireless communication channel which is estimated by the downlink communication quality estimator 2109, into an uplink control signal, as a process for the uplink communication. An encoding/modulation unit 2128 encodes and modulates a data sequence from the uplink reception data buffer 2127, in accordance with control information peculiar to the same data sequence.

The layer map unit 2129 is the same as the block 1714, and arranges a modulation symbol on a sub-carrier or OFDM symbol represented in control information peculiar to the above-described data sequence.

A pre-coding unit 2130 performs a process for multiplying a pre-coding matrix as a transmission weight matrix, while handling a plurality of spatial layers of a layer map output from the layer map unit 2129 as a vector. This process is executed for the entire OFDM symbols and sub-carriers.

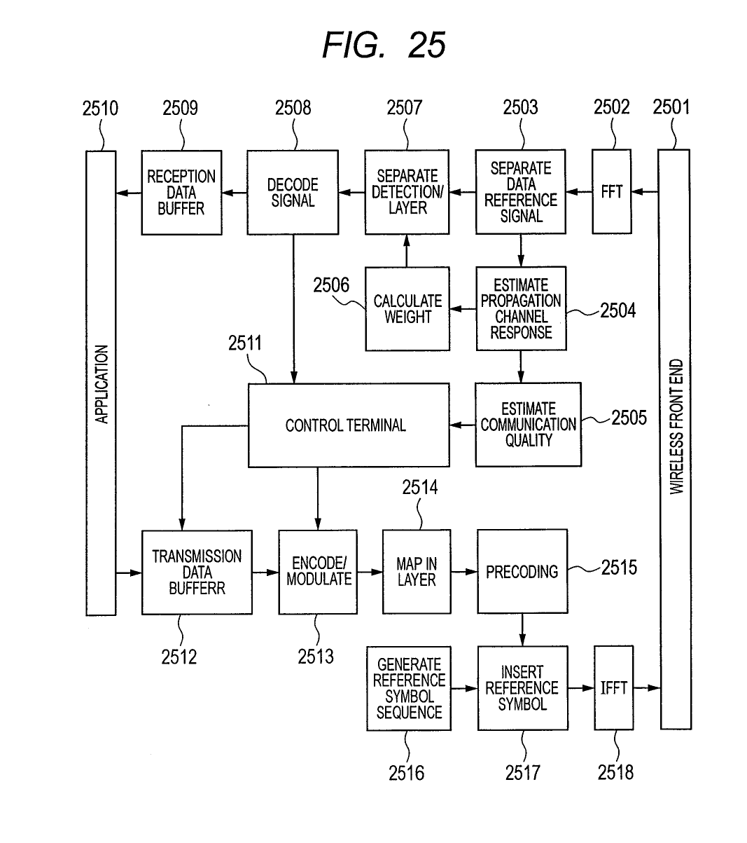

A reference symbol insertion unit 2131 is a block for generating an uplink reference signal symbol sequence. This may be the same as a reference signal symbol generated by a block 2516 of a terminal shown in FIG. 25. However, if reference signal symbols are set to overlap each other in the OFDM symbol and the sub-carrier that are the same as the reference signal symbol sequence of the base station, another sequence having cross correlation as low as possible is used. The method for generating the reference signal symbol sequence is the same as the block 1716.

A reference symbol sequence generation unit 2132 performs a process for inserting the reference signal symbol sequence generated by the reference symbol sequence generation unit 2131 into a part of a blank symbol in the pre-coding output of the pre-coding unit 2130. Upon completion of this insertion process, an IFFT unit 2133 performs an IFFT process for each OFDM symbol, and outputs this to the base station side wireless front end 2101.

Parts, except the above-described front ends 2101 and 2102, can be realized using a logic circuit, or a processor, such as a DSP, MPU.

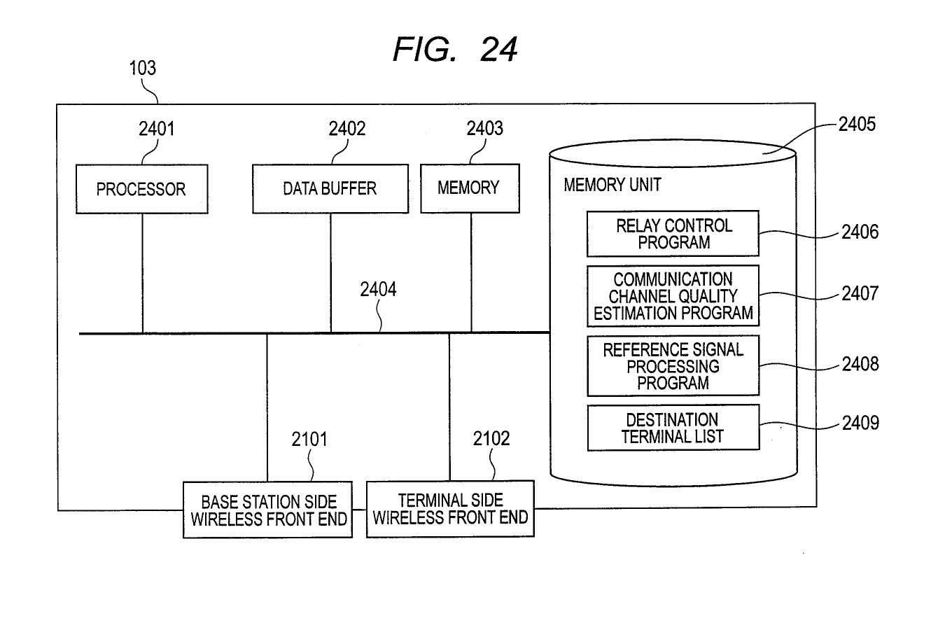

FIG. 24 is a diagram showing an embodiment of a device configuration of the relay device 103. Like the above-described base station, the relay device 103 includes a processor 2401 as a processing unit and a data buffer 2402 and a memory 2403 as storage units, which are connected with each other through an internal bus 2404. The device includes also the base station wireless front end 2101 and the terminal side wireless front end 2102, as network I/Fs. The relay device 103 has a memory unit 2405 as a storage unit for storing programs or tables.

The memory unit 2405 stores a relay control program 2406, a communication channel quality estimation program 2407, a reference signal processing program 2408, and a destination terminal list 2409. The programs are stored in the memory 2403 as needed, and are executed by the processor 2401 as a processing unit. The programs or information corresponding to the processes of the relay device 103 disclosed in this specification include any of those that are not illustrated. For example, in FIG. 15, such information includes a corresponding list of the terminal IDs and SRS transmission patterns or threshold value of the SRS reception intensity used in the updating process of the destination terminal list.

The relay control program 2406 is a program whose processes corresponding to the operations of FIG. 6A and FIG. 14 are defined. If the relay control program 2406 is read by the processor 2401, it corresponds to the relay device control block 2104 of FIG. 22 or FIG. 23. The communication channel quality estimation program 2407 corresponds to the communication quality estimators 2109 and 2123 of FIG. 22 and FIG. 23. The reference signal processing program 2408 corresponds to the reference symbol sequence generation units 2117 and 2131 of FIG. 22 and FIG. 23, and also corresponds to the processes performed by the reference symbol insertion units 2118 and 2132.

The destination terminal list 2409 is a list for managing IDs of destination terminals of the relay device through the second wireless communication channel, as shown in 1101 and 1102 of FIG. 11.

The processor 2401 executes the programs stored in the memory unit 2405. The processor executes a program for executing a process corresponding to the relay device control block 2104, and controls wireless communication with reference to the destination terminal list 2409.

The data buffer 2402 corresponds to 2113 of FIGS. 22 and 2127 of FIG. 23. The memory 2403 keeps the developed programs to be processed by the processor 2401 and data necessary for processes.

Needless to say, the wireless front end units 2101 and 2102 are interfaces for transmitting/receiving the wireless signal to/from the base station or the terminal device.

FIG. 25 is a diagram showing an embodiment of a functional block configuration in the terminal.

A wireless front end unit 2501 has constituent elements that correspond to the configuration of the wireless front end 1701 of FIG. 17.

An FFT unit 2502 performs an FFT process for a downlink reception baseband signal, and a data reference signal separator 2503 separates the signal into a data symbol and a reference signal symbol.

A propagation channel response estimator 2504 estimates a response through a downlink wireless communication channel and a downlink second wireless communication channel, for the reference signal symbol obtained by the data reference signal separator 2503. Estimation of the propagation channel response uses a known reference signal symbol on both of the transmission/reception sides (between terminal and base station, and between relay device and terminal). If the reference signal symbol does not change with time, the storage unit keeps a fixed and known reference signal symbol sequence. If the reference signal symbol changes with time, a reference signal symbol sequence is generated, in accordance with a rule of the reference signal symbol sequence shared between the transmission side and the reception side.

If a plurality of reference signal symbol sequences with low cross correlation are multiplexed at the same time and into the same frequency, or if different reference signal symbol sequences are transmitted at the same time and in the same frequency between terminals, between relay devices, or between a terminal and a relay device, the received reference signal symbol sequence is stored in the middle register 1904 such that the head symbol comes at the right side, as shown in FIG. 19. The complex conjugate of a known first reference symbol sequence is stored in the upper register 1901 such that the head comes at the right side. Further, the complex conjugate of a known second reference signal symbol sequence is stored in the lower shift register 1905 such that the head comes at the right side.

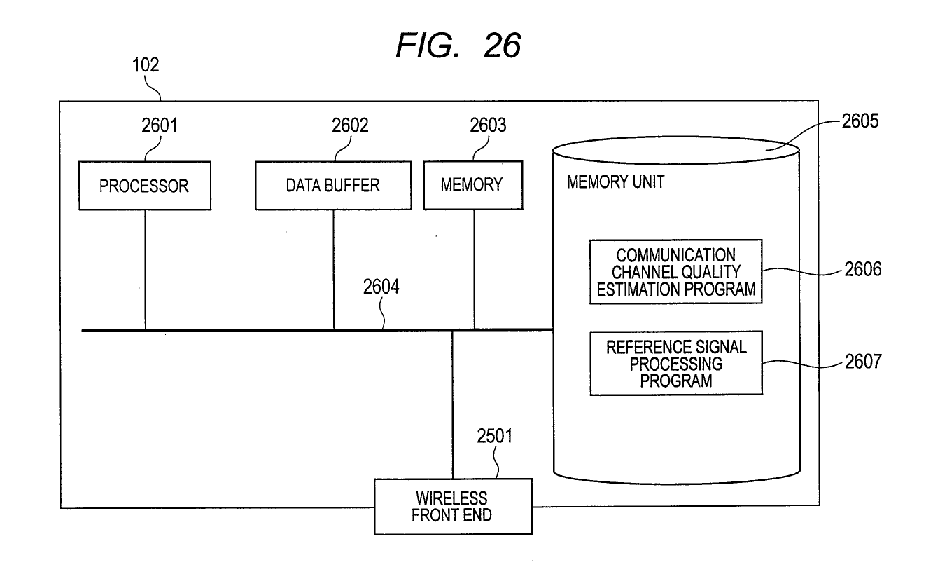

In this state, as shown in the illustration, the adders 1903 and the multipliers 1902 perform multiplication and addition, thereby acquiring a propagation channel response for the first reference signal and a propagation channel response for the second reference signal symbol. In this case, the received reference signal symbol sequence is input from the data reference signal separator 2503. The known first reference signal symbol and the second reference signal symbol are input from the storage unit (memory 2603 of FIG. 26) for storing a fixed sequence used by the propagation channel estimator 2504, or input based on a generated result in accordance with a rule of the reference signal symbol sequence shared between the transmission side and the reception side in the propagation channel response estimator 2504.

A communication quality estimator 2505 estimates communication quality based on an estimated result of the propagation channel of the propagation channel response estimator 2504. The estimator estimates the communication quality of both of the downlink first communication wireless communication channel and the downlink second wireless communication channel. The method of estimating the communication quality is the same as the block 1705.

The communication quality of the downlink first wireless communication channel and the communication quality of the downlink second wireless communication quality that have been estimated by the propagation channel response estimator 2505 are input to a terminal control block 2511.

A weight calculator 2506 and a detection/layer separator 2507 are the same as the weight calculator 1706 and the detection/layer separator 1707.

A demodulation/decoding unit 2508 gathers data symbols divided into spatial layers by the detection/layer separator 2507 in the unit of code words, obtains a log likelihood ratio for each bit, and performs Turbo decoding or Viterbi decoding. The decoded result is stored in a reception data buffer 2509, and control information is input to the base station control block 2511. As the control information, uplink packet schedule information issued by the control block 1711 in the base station is input to the terminal control block 2511. A difference between data and the control information is made in accordance with a protocol of a wireless I/F that is issued by a standardization organization, in conformity to the corresponding wireless communication system.

An application 2510 may be a processor and a user interface. This processor is to operate a Web or email application for use in the terminal. The user interface includes a screen or a keyboard. Data input from the application 2510 is stored in a transmission data buffer 2512, and is transmitted in accordance with scheduling information generated by the base station.

The terminal control block 2511 drives an encoding/modulation unit 2513, in accordance with an estimated result of the communication quality which is obtained by the communication quality estimator 2505 and uplink packet scheduling information obtained by the demodulation/decoding unit 2508. The block performs a process for inputting the estimated result of the communication quality which has been input from the communication quality estimator 2505 to the encoding/modulation unit 2513, as uplink control information. Further, when the uplink data sequence generated by the application 2510 exists in the transmission data buffer 2512, the block inputs a scheduling request for requesting the base station for uplink packet scheduling to the encoding/modulation unit 2513, as control information.

The encoding/modulation unit 2513 encodes and modulates a data sequence from the transmission data buffer 2512 and a control information sequence from the terminal control block 2511. The encoding method and the modulation methods are the same as those of the encoding/modulation unit 1713.

A layer map unit 2514 and a pre-coding unit 2515 are the same as the layer map unit 1714 and the pre-coding unit 1715.

A reference symbol sequence generation unit 2516 is a block for generating an uplink reference signal symbol sequence. A method for generating a reference signal symbol sequence is the same as that of the reference symbol sequence generation unit 1716.

A reference symbol insertion unit 2517 performs a process for inserting the reference signal symbol sequence generated by the reference symbol sequence generation unit 2516 into a part of a blank symbol in a pre-coding output of the pre-coding unit 2515. Upon completion of the insertion, an IFFT 2518 performs an IFFT process for each OFDM symbol, and outputs it to the wireless front end 2501.

Those parts, except the above wireless front end 2501 and the application 2510, can be realized using a logic circuit or a processor as a processing unit, such as a DSP, an MPU, as will be described later.

FIG. 26 is a diagram showing an embodiment of a device configuration of the terminal 102.

The terminal 102 includes a processor 2601 as a processing unit, a data buffer 2602 and a memory 2603 as storage units, which are connected with each other through an internal bus 2604. Further, the terminal 102 has the wireless front end 2501 as a network I/F. The terminal 102 has a memory unit 2605 as a storage unit which stores programs and tables.

The memory 2605 stores a communication channel quality estimation program 2606 and a reference signal processing program 2607. The programs are stored in the memory 2603 as needed, and are executed by the processor 2601 as a processing unit. The terminal 102 may store data received from the base station or relay device into the memory unit 2605 or the memory 2603. The programs corresponding to the processes of the terminal 102 disclosed in this description include any of those that are not illustrated.

The communication channel quality estimation program 2606 corresponds to the communication quality estimator 2505 of FIG. 25. The reference signal processing program 2607 corresponds to the programs performed by the reference symbol sequence generation unit 2516 and the reference symbol insertion unit 2517 of FIG. 25.

The processor 2601 executes the programs stored in the memory unit 2605. The processor 2601 executes the programs, executes processes corresponding to the terminal control block 2511, and controls wireless communication.

The data buffer 2602 corresponds to 2509 and 2512 of FIG. 25. The memory 2603 keeps the developed program to be processed by the processor 2601, and keeps data necessary for the process.

The wireless front end unit 2501 is an interface for transmitting/receiving a wireless signal to/from the base station or the relay device, like FIG. 25.

LTE has a system called an SPS (Semi-Persistent Scheduling) for periodically allocating a resource(s) to a particular terminal(s). In application of this, a resource for retransmission is kept in advance with the SPS, at the transmission of a new packet(s), thereby not requiring acquisition of resource allocation information through the third wireless communication channel in the retransmission.

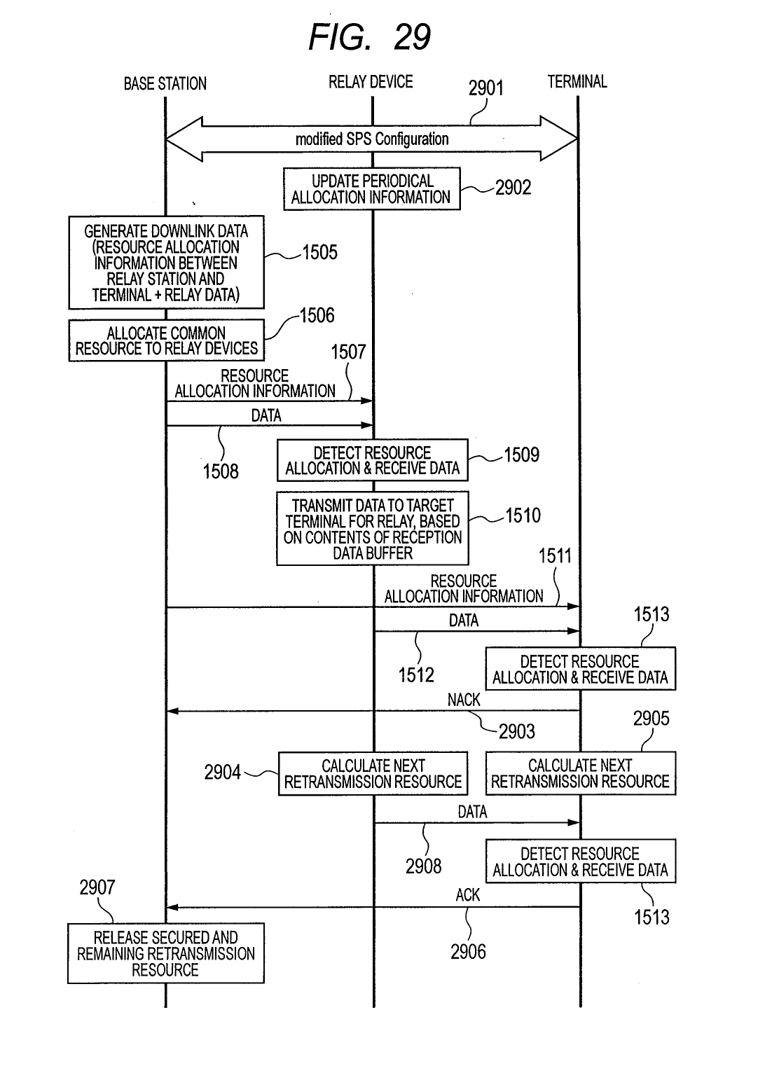

An operational sequence in the system with this SPS is explained with FIG. 29. The base station informs in advance the terminal to perform periodical resource allocation, using a signal 2901 on the basis of an SPS-Configuration as an existing RRC layer signal. In the existing SPS, only the first transmission resource of H-ARQ as will be explained later is kept. However, the contents of the signal 2901 in this system have a configuration of specifying the resource for retransmission. Infinite retransmission deteriorates the efficiency of the system. Thus, the signal 2901 includes the maximum number of retransmissions, and is sent to the terminal. This can be realized by adding a field representing resource acquirement for retransmission or a field representing the maximum number of retransmissions, into the existing SPS-configuration, in addition to defining a new signal. The relay device intercepts this signal 2901, thereby updating information for managing the circumstances of the periodical allocation of the terminal (2902). Alternately, the base station may periodically inform the relay device about this management information. The relay device stores the management information regarding this periodical allocation into the memory unit 2405. In the functional block of the relay device explained in FIG. 22, the relay device control block 2104 may keep the management information regarding this periodical allocation, and the relay device control block 2104 may control data transmission of 1512 based on the management information regarding the periodical allocation. Alternately, the reception data buffer 2113 may keep the management information regarding this periodical allocation, and the relay device control block 2104 may control data transmission of 1512 with reference to the management information regarding the periodical allocation kept in the reception data buffer 2113.

Like FIG. 15, the base station transmits data to the terminal through the relay device in accordance with operations from Step 1505 to 1513. When a result of the reception operation 1513 shows a success in reception, the terminal feeds back information representing ACK (ACKnowledge) to the base station. When the result shows a failure in reception, the terminal feeds back information representing NACK (Negative ACKnowledge) to the base station. The relay device intercepts this information. When the information fed back by the terminal is NACK (2903), the relay device and the terminal refer to common periodical allocation information that is managed by themselves. When the terminal is a target terminal for periodical allocation, and when the number of retransmissions is equal to or smaller than the maximum number of retransmissions specified in 2901, they calculate a resource for use in the next retransmission in accordance with the retransmission period specified in 2901 (2904, 2905). In this case, the frequency resource is informed in advance, and the time resource can be obtained based on the period in the first resource allocation (1511) and the periodical allocation information.

When the information fed back by the terminal is ACK (2906), the base station detects that retransmission is not necessary from this on, releases a resource for the remaining retransmission(s) that is kept using the information of 2901, and uses the resource for transmission of another packet (2907).

There may no need to acquire the resource allocation information through the third wireless communication channel in the retransmission, with utilization of H-ARQ as a retransmission control operation for the packet in the mobile communication. In asynchronous H-ARQ wherein retransmission packets are transmitted at an arbitrary timing, the retransmission requires an operation accompanying the second wireless communication channel control signal 406. However, in synchronous H-ARQ wherein retransmission packets are transmitted at predetermined periods, the second wireless communication channel control signal 406 may be omitted in the retransmission. At this time, in the DF type, the relay device keeps data bit sequences. Thus, when generation of the retransmission packets is done independently by the relay device, information (e.g. 501 to 505 of FIG. 5), for a target terminal for H-ARQ retransmission, in the third wireless communication channel data signal 404 may be omitted. Retransmission periods in the synchronous H-ARQ may be specified by adding a field (information) representing the retransmission periods into “System Information Block Type 2” as an RRC (Ratio Resource Control) layer signal with which the base station informs the terminal about system information, for example, in LTE. The frequency resource for use in the retransmission is the same as the frequency resource used in the first transmission. Thus, there is no need inform the terminal about the frequency resource for each retransmission. Further, with the same “System Information Block Type 2”, a variation (offset) of the frequency resource of each retransmission from the frequency resource used in the first transmission is specified. As a result, the transmission may be achieved using different frequencies between retransmissions. The operational sequence in the system using this H-ARQ can be realized by informing the relay device about the “System Information Block Type 2” in 2901, and by updating information for managing the circumstances of the periodical allocation of the terminal (2902), as explained in FIG. 29.

According to the system using the above-described SPS or H-ARQ, the resource information for use in the retransmission is shared between the relay device and the terminal. Thus, when data is retransmitted (2908), transmission of the resource allocation information like 1511 can be omitted. This enables to contribute to utilization efficiency improvement of the wireless resource in the system.

### INDUSTRIAL APPLICABILITY

It is useful in a base station, a terminal, a relay device, and a wireless communication system having them. It is useful, particularly, in a data transmission control technique in the base station and the relay device.

### REFERENCE SIGNS LIST

101 . . . Base Station
102 . . . First Terminal
103 . . . First Relay Device
104 . . . First Wireless Communication Channel Between Base Station-Terminal
105 . . . Second Wireless Communication Channel Between Relay Device-Terminal
106 . . . Third Wireless Communication Channel Between Base Station-Relay Device
107 . . . Radio Communication Resource Allocated To First Wireless Communication Channel
108 . . . Radio Communication Resource Allocated To Second Wireless Communication Channel
109 . . . Radio Communication Resource Allocated To Third Wireless Communication Channel
110 . . . Second Relay Device
111 . . . Second Terminal
112 . . . Third Terminal
113 . . . Fourth Terminal
114 . . . Fifth Terminal
115 . . . Sixth Terminal
401 . . . One Wireless Communication Channel Control Signal
402 . . . First Wireless Communication Channel Data Signal
403 . . . Third Wireless Communication Channel Control Signal
404 . . . Third Wireless Communication Channel Data Signal
405 . . . Transmission Data Second Wireless Communication Channel Received By First Relay Device
406 . . . Second Wireless Communication Channel Control Signal Used By First Relay Device
407 . . . Second Wireless Communication Channel Data Signal Transmitted By First Relay Device
501 . . . First Id of Destination Terminal For Second Wireless Communication Channel Transmission Data
502 . . . Second Transmission Time For Second Wireless Communication Channel Transmission Data
503 . . . First Used Frequency Resource Of Second Wireless Communication Channel Transmission Data
504 . . . First Encoding/Modulation Scheme Of Second Wireless Communication Channel Transmission Data
505 . . . First Transmission Data Of Second Wireless Communication Channel
506 . . . Second Destination Terminal Id Of Second Wireless Communication Channel Transmission Data
507 . . . Second Transmission Time Of Second Wireless Communication Channel Transmission Data
508 . . . Second Used Frequency Resource Of Second Wireless Communication Channel Transmission Data
509 . . . Second Encoding/Modulation Scheme Of Second Wireless Communication Channel Transmission Data
510 . . . Second Transmission Data Of Second Wireless Communication Channel
601 . . . Step Of Judging Whether There Is Resource Allocation Of Third Wireless Communication Channel
602 . . . Step Of Decoding Data Transmitted With Allocated Resource
603 . . . Step Of Storing Received Data In Reception Data Buffer
604 . . . Step Of Judging Whether It Is necessary To Transmit Data With Second Wireless Communication Channel At Current Time
605 . . . Step of Encoding/Modulating Transmission Data With Second Wireless Communication Channel
606 . . . Step Of Mapping Transmission Data Of Second Wireless Communication Channel in Frequency Resource
701 . . . Transmission Data Contents Of Third Wireless Communication Channel Which Is Addressed To First Relay Device
702 . . . Transmission Data Contents Of Third Wireless Communication Channel Which Is Addressed To Second Relay Device
801 . . . Third Wireless Communication Channel Control Signal
802 . . . Third Wireless Communication Channel Data Signal
803 . . . Transmission Data Of Third Wireless Communication Channel Which Is Received Commonly By Entire Relay Devices
804 . . . Second Wireless Communication Channel Control Signal Commonly Used By Entire Relay Devices
805 . . . Second Wireless Communication Channel Data Signal Transmitted Commonly By Entire Relay Devices
901 . . . Transmission Data Contents Of Third Wireless Communication Channel Addressed Commonly To Entire Relay Devices
902 . . . Second Wireless Communication Channel Data Transmission From First Relay Device To Fourth Terminal
903 . . . Second Wireless Communication Channel Data Transmission From First Relay Device To Third Terminal
904 . . . Second Wireless Communication Channel Data Transmission From Second Relay Device To Second Terminal
905 . . . Second Wireless Communication Channel Data Transmission From Second Relay Device to First Terminal
1001 . . . Destination Terminal List Of Second Wireless Communication Channel Which Is Managed By First Relay Device
1002 . . . Second Wireless Communication Channel Control Signal Used By First Relay Device
1003 . . . Second Wireless Communication Channel Data Signal Transmitted By First Relay Device
1101 . . . Destination Terminal List Of Second Wireless Communication Channel Which Is Managed By First Relay Device
1102 . . . Destination Terminal List Of Second Wireless Communication Channel Which Is Managed By Second Relay Device
1201 . . . Uplink Signal Transmitted By First Terminal To Base Station
1202 . . . Uplink Signal Transmitted By Second Terminal To Base Station
1203 . . . Uplink Signal Transmitted By Third Terminal To Base Station
1204 . . . Uplink Signal Transmitted By Fourth Terminal To Base Station
1205 . . . Uplink Signal Transmitted By Fifth Terminal To Base Station
1206 . . . Uplink Signal Transmitted By Sixth Terminal To Base Station
1301 . . . Id Of Terminal Belonging To Base Station
1302 . . . SRS Transmission Pattern ID Allocated To Each Terminal ID
1401 . . . Step Of Measuring Reception Intensity Of Uplink Signal From Each Terminal
1402 . . . Step Of Comparing Measured Reception Intensity Of Uplink Signal With Predetermined Threshold Value
1403 . . . Step Of Adding Terminal With Reception Intensity Equal To Or Greater Than Threshold Value Into Destination Terminal List
1404 . . . Step Of Judging Whether There Is Resource Allocation of Third Wireless Communication Channel
1405 . . . Step Of Collating Received Data With Destination Terminal List And Storing In Reception Data Buffer
1501 . . . Uplink Reference Signal Transmitted From Terminal
1502 . . . Uplink Communication Channel Quality Estimation Of First Wireless Communication Channel Using Reference Signal 1501 Of Base Station
1503 . . . Uplink Communication Channel Quality Estimation Of Second Wireless Communication Channel Using Reference Signal 1501 Of Relay Device
1504 . . . Process Of Adding Terminal With Uplink Communication Quality, Equal To Or Greater Than Threshold Value, Of Relay Device Into Downlink Destination Terminal List Of Second Wireless Communication Channel
1505 . . . Process For Forming Transmission Data Of Third Wireless Communication Channel Of Base Station
1506 . . . Process For Resource Allocation And Generating Allocation Information Of Third Wireless Communication Channel Of Base Station
1507 . . . Third Wireless Communication Channel Allocation Information Transmitted From Base Station
1508 . . . Third Wireless Communication Channel Transmission Data Transmitted From Base Station
1509 . . . Process For Receiving Third Wireless Communication Channel Downlink Data Of Relay Device
1510 . . . Process For Transmitting Data Of Second Wireless Communication Channel Of Relay Device
1511 . . . Second Wireless Communication Channel Resource Allocation Information Transmitted From Base Station Or Relay Device
1512 . . . Second Wireless Communication Channel Transmission Data Transmitted From Relay Device
1513 . . . Process For Receiving Second Wireless Communication Channel Downlink Data of Terminal Device
1601 . . . Transmission Data Contents Of Third Wireless Communication Channel Addressed Commonly To Entire Relay Devices
1602 . . . Transmission Data Contents Of Third Wireless Communication Channel Addressed Commonly To First Relay Device
1603 . . . Transmission Data Contents Of Third Wireless Communication Channel Addressed Commonly To Second Relay Device
1701 . . . Wireless Front End Of Base Station
1702 . . . Uplink FFT Process Of Base Station
1703 . . . Separation For Data Symbol/Reference Signal Symbol Of Base Station
1704 . . . Estimation Of Propagation Channel Response Of Base Station
1705 . . . Estimation Of Uplink Communication Quality of Base Station
1706 . . . Receive Weight Calculation For Base Station
1707 . . . Detection/Layer Separation For Base Station
1708 . . . Uplink Demodulation/Decoding Of Base Station
1709 . . . Uplink Reception Data Buffer Of Base Station
1710 . . . I/F For Wired Backhaul Network Of Base Station
1711 . . . Base Station Control Unit
1712 . . . Downlink Data Buffer Of Base Station
1713 . . . Encode/Modulate For Base Station
1714 . . . Layer Mapping Process Of Base Station
1715 . . . Pre-coding Process of Base Station
1716 . . . Generate Downlink Reference Signal Symbol Sequence Of Base Station
1717 . . . Process For Inserting Downlink Reference Signal Symbol Of Base Station
1718 . . . Downlink IFFT Process Of Base Station
1801 . . . Processor Of Base Station Device
1802 . . . Data Buffer Of Base Station Device
1803 . . . Memory Of Base Station Device
1804 . . . Internal Data Bus Of Base Station Device
1805 . . . Memory Unit Of Base Station Device
1806 . . . Program For Judging Whether Soft Handover Is Necessary, Of Base Station Device
1807 . . . Program For Measuring Communication Channel Quality Of Base Station Device
1808 . . . Program For Reference Signal Processing Of Base Station Device
1809 . . . Destination Terminal List Of Each Relay Device Which Is Managed by Base Station Device
1810 . . . Table Referred When Base Station Device Obtains Communication Channel Quality
1901 . . . Shift Register
1902 . . . Multiplier
1903 . . . Adder
2101 . . . Base Station Side Wireless Front End Of Relay Device
2102 . . . Terminal Side Wireless Front End Of Relay Device
2103 . . . Downlink Baseband Signal Process Of Relay Device
2104 . . . Relay Device Control
2105 . . . Uplink Baseband Signal Process Of Relay Device
2106 . . . Downlink FFT Process Of Relay Device
2107 . . . Separation For Downlink Data Symbol/Reference Signal Symbol Of Relay Device
2108 . . . Estimation Of Downlink Propagation Channel Response Of Relay Device
2109 . . . Estimation Of Downlink Communication Quality Of Relay Device
2110 . . . Calculate Downlink Receive Weight Of Relay Device
2111 . . . Separate For Downlink Detection/Layer Of Relay Device
2112 . . . Downlink Demodulation/Decoding Of Relay Device
2113 . . . Downlink Reception Data Buffer Of Relay Device
2114 . . . Downlink Encoding/Modulation Of Relay Device
2115 . . . Downlink Layer Mapping Process Of Relay Device
2116 . . . Downlink Pre-coding Process Of Relay Device
2117 . . . Downlink Reference Signal Symbol Sequence Generation Of Relay Device
2118 . . . Downlink Reference Signal Symbol Sequence Insertion Process Of Relay Device
2119 . . . Downlink IFFT Process Of Relay Device
2120 . . . Uplink FFT Process Of Relay Device
2121 . . . Separation For Uplink Data Symbol/Reference Signal Symbol Of Relay Device
2122 . . . Estimation Of Uplink Propagation Channel Response Of Relay Device
2123 . . . Estimation Of Uplink Communication Quality Of Relay Device
2124 . . . Uplink Receive Weight Calculation Of Relay Device
2125 . . . Uplink Detection/Layer Separation Of Relay Device
2126 . . . Uplink Demodulation/Decoding Of Relay Device
2127 . . . Uplink Reception Data Buffer Of Relay Device
2128 . . . Uplink Encoding/Modulation Of Relay Device
2129 . . . Uplink Layer Mapping Process Of Relay Device
2130 . . . Uplink Pre-coding Process Of Relay Device
2131 . . . Uplink Reference Signal Symbol Sequence Generation Of Relay Device
2132 . . . Uplink Reference Signal Symbol Insertion Process Of Relay Device
2133 . . . Uplink IFFT Process Of Relay Device
2401 . . . Process Of Relay Device
2402 . . . Data Buffer Of Relay Device
2403 . . . Memory Of Relay Device
2404 . . . Internal Data Bus Of Relay Device
2405 . . . Memory Unit Of Relay Device
2406 . . . Relay Control Program Of Relay Device
2407 . . . Program For Measuring Communication Channel Quality, Of Relay Device
2408 . . . Reference Signal Processing Program Of Relay Device
2409 . . . Destination Terminal List Managed By Relay Device
2501 . . . Wireless Front End Of Terminal
2502 . . . Downlink FFT Process Of Terminal
2503 . . . Data Symbol/Reference Signal Symbol Separation Of Terminal
2504 . . . Estimation Of Propagation Channel Response Of Terminal
2505 . . . Estimation Of Downlink Communication Quality Of Terminal
2506 . . . Receive Weight Calculation Of Terminal
2507 . . . Detection/Layer Separation Of Terminal
2508 . . . Downlink Demodulation/Decoding Of Terminal
2509 . . . Downlink Reception Data Buffer Of Terminal
2510 . . . Device For Operating Application On Terminal
2511 . . . Terminal Control Unit
2512 . . . Uplink Transmission Data Buffer Of Terminal
2513 . . . Encoding/Modulation Of Terminal
2514 . . . Layer Mapping Process Of Terminal
2515 . . . Pre-coding Process Of Terminal
2516 . . . Uplink Reference Signal Symbol Sequence Generation Of Terminal
2517 . . . Uplink Reference Signal Symbol Insertion Process Of Terminal
2518 . . . Uplink IFFT process Of Terminal
2601 . . . Processor Of Terminal
2602 . . . Data Buffer Of Terminal
2603 . . . Memory Of Terminal
2604 . . . Internal Data Bus Of Terminal
2605 . . . Memory Unit Of Terminal
2606 . . . Program For Measuring Communication Channel Quality Of Terminal Device
2607 . . . Reference Signal Processing Program Of Terminal
2701 . . . Third Relay Device
2702 . . . Fourth Relay Device
2703 . . . Seventh Terminal
2704 . . . Eighth Terminal
2705 . . . Destination Terminal List Of Second Wireless Communication Channel Managed By Third Relay Device
2706 . . . Destination Terminal List Of Second Wireless Communication Channel Managed By Fourth Relay Device
2707 . . . Transmission Data Of Third Wireless Communication Channel Addressed Commonly To First And Second Relay Devices
2708 . . . Transmission Data Of Third Wireless Communication Channel Addressed Commonly To Third And Fourth Relay Devices
2801 . . . Id Of Relay Device Group
2802 . . . Id Of Relay Device Belonging To Each Group
2901 . . . Inform Periodical Allocation Information Transmitted By Base Station To Terminal
2902 . . . Process For Updating Periodical Allocation Information For Each Terminal
2903 . . . Feedback Information From Terminal Representing Failure Of Data Transmission
2904 . . . Retransmission Resource Calculation Process Of Relay Device Based On Periodical Allocation Information
2905 . . . Retransmission Resource Calculation Process Of Terminal Based On Periodical Allocation Information
2906 . . . Feedback Information Representing Success In Data Transmission, From Terminal
2907 . . . Resource Release Process For Retransmission Of Base Station, Based On Success Information Of Transmission And Periodical Allocation Information

1. A wireless communication system comprising:
a wireless base station;
a wireless relay station which can communicate with the wireless base station; and
a plurality of wireless terminals which communicate with the wireless base station through the wireless relay station, wherein
the wireless relay station receives a plurality of data items addressed to the wireless terminals from the wireless base station, and transmits the received data items addressed to a first wireless terminal as a selected destination wireless terminal for data transmission, of the wireless terminals.

2. The wireless communication system according to claim 1, wherein
the wireless relay station selects the first wireless terminal, based on reception quality of a signal received by the wireless relay station from the wireless terminal.

3. The wireless communication system according to claim 2, wherein
the signal received by the wireless relay station from the wireless terminal is a reference signal which is transmitted by the wireless terminal for the wireless base station.

4. The wireless communication system according to claim 2, wherein
the wireless relay station selects the wireless terminal having reception quality of the signal received by the wireless relay station from the wireless terminal, the reception quality being greater than a predetermined threshold value.

5. The wireless communication system according to claim 2, wherein
the wireless relay station eliminates the terminal having reception quality of the signal received by the wireless relay station from the wireless terminal, from the first terminal, the reception quality being equal or lower than a predetermined threshold value for or longer than a predetermined period of time.

6. The wireless communication system according to claim 1, wherein
the wireless relay station receives relay destination information representing a candidate wireless terminal for the first wireless terminal from the wireless base station, and selects the candidate wireless terminal as the first wireless terminal based on the relay destination information.

7. The wireless communication system according to claim 6, wherein
the wireless base station selects the candidate wireless terminal based on a location relationship between the plurality of wireless terminals and the wireless relay station.

8. The wireless communication system according to claim 6, wherein
the base station selects the candidate wireless terminal based on propagation channel information between the wireless terminal and the wireless base station, the information being measured by the wireless terminal.

9. The wireless communication system according to claim 1, wherein
the wireless relay station selects the wireless terminal whose ACK signal has not reached the wireless base station, as the first terminal.

10. The wireless communication system according to claim 1, wherein:
the wireless base station transmits relay control information representing correspondence between a wireless resource and the wireless terminal and used by the wireless relay station for transmitting data addressed to the plurality of wireless terminals; and
the wireless relay station judges a first wireless resource having correspondence with the first wireless terminal based on the relay control information, and transmits data addressed to the first wireless terminal using the judged wireless resource.

11. The wireless communication system according to claim 10, wherein
the wireless relay station stores a time period and the first wireless resource for transmitting data addressed to the first wireless terminal, based on the received relay control information, and
transmits data using the first wireless resource, based on the time period.

12. The wireless communication system according to claim 10, wherein
the wireless relay station includes a plurality of wireless relay stations, and
the wireless base station transmits the data addressed to the wireless terminal and the relay control information in a same time slot using a same wireless resource, to the plurality of relay stations.

13. A wireless communication system comprising:
a wireless base station;
a plurality of wireless relay stations which can communication with the wireless base station; and
a plurality of wireless terminals which communicate with the wireless base station through the wireless relay stations, wherein the plurality of wireless relay stations
have a destination terminal list representing the wireless terminals as destinations,
receive relay control data about the wireless terminal as a destination and a wireless resource used for transmitting the data to the wireless terminals, from the wireless base station,
select a first wireless terminal as a destination wireless terminal for data transmission, based on the destination terminal list, and
transmit the data to the selected first wireless terminal, using a corresponding wireless resource.

14. The wireless communication system according to claim 13, wherein:
the plurality of wireless relay devices are groups into a plurality of groups respectively having common IDs; and
the wireless base station gathers data of the wireless terminals belonging to the groups, and transmits it having its corresponding ID affixed thereto, when the data and the relay control information are transmitted.

15. A relay terminal selection method in a wireless relay station which can communicate with a wireless base station and a plurality of wireless terminals, the method comprising:
receiving data addressed to the plurality of wireless terminals from the wireless base station;
judging a first wireless terminal as a destination wireless terminal for data transmission; and
transmitting the data to the first wireless terminal.

16. The relay terminal selection method according to claim 15, further comprising
judging the first wireless terminal, based on reception quality of a signal received by the wireless relay station from the wireless terminal.

17. The relay terminal selection method according to claim 16, further comprising
judging the wireless terminal having reception quality of a signal received by the wireless relay station from the wireless terminal as the first wireless terminal, the reception quality being greater than a predetermined threshold value.

18. The relay terminal selection method according to claim 16, further comprising
eliminating the wireless terminal having reception quality of the signal received by the wireless station from the wireless terminal, from the first wireless terminal, the reception quality being equal to or lower than a predetermined threshold value for or longer than a predetermined period of time.

19. The relay terminal selection method according to claim 15, further comprising:
receiving relay destination information representing a candidate wireless terminal for the first wireless terminal from the wireless base station; and
judging the candidate wireless terminal as the first wireless terminal in accordance with the relay destination information.

20. The relay terminal selection method according to claim 19, further comprising:
receiving relay control information representing correspondence between a wireless resource used for transmitting the data addressed to the plurality of wireless terminals and the wireless terminals;
judging a first wireless resource corresponding to the first wireless terminal based on the relay control information, as a frequency resource for use in data transmission for the first wireless terminal; and
transmitting data addressed to the first wireless terminal, using the judged first wireless resource.
